(19) United States
(12) Patent Application Publication
(10) Pub. No.: US 2005/0261986 A1
(43) Pub. Date: Nov. 24, 2005

(54) On-line truck rental and reservation system and method

(76) Inventors: Tim Haynes, Reading, PA (US); David Baptisti, Reading, PA (US); Don Mikes, Sinking Spring, PA (US); Michael R. Kersic, Coatesville, PA (US); Sherry Newbaker, Bernville, PA (US); Kendra J. Hommas, Denver, PA (US); George A. Schmidt, Downingtown, PA (US); Susan Ann Kremser, Wernersville, PA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/193,570

(22) Filed: Jul. 29, 2005

Related U.S. Application Data
(63) Continuation of application No. 09/459,189, filed on Dec. 10, 1999.

(51) Int. Cl. G06F 17/60

(52) U.S. Cl. 705/26

(57) ABSTRACT

A computer-based system and method provide truck-rental information and expertise-based guidance to facilitate a customer's reserving and renting of a truck using a communications network. The system includes a server which processes user inputs from a user's computer over a communications network and provides information responsive thereto to the user's computer over the communications network from which a service contract is generated and confirmed. The server includes a memory and programming. In the memory, a plurality of data sets is stored relating to (a) trucks which can be rented and associated rental prices for the trucks, (b) towing accessories that can be rented and towed vehicles with which the towing accessories can be used, (c) towing accessories and associated rental prices for the towing accessories, (d) expertise-based guidance relating to trucks, and (e) expertise-based guidance relating to towing accessories. The programming responds to user inputs to access the memory and provide data from respective data sets to user computer over the communications network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND OF THE INVENTION

The present invention relates to electronic (e.g., on-line and Internet-based) reservation systems, and, more particularly, to an integrated on-line truck rental and reservation system and method.

Services providers and carriers such as airlines, car and truck rentals, and hotel and other lodging facilities often deal with customers and potential customers over wide geographic areas. To conveniently provide their services, such service providers and carriers establish multiple service outlets distributed throughout a given geographic area.

To coordinate services among the distributed outlets, centralized service distribution facilities and functions are often implemented. For many decades, the telephone has been the communications medium of choice, for example, using 800 numbers, to route customer inquiries to service centers in order to provide information, to make reservations for services, and to establish service contracts and payment methods using, for example, remote credit card transactions.

However, staffing of call service centers is labor-intensive. In addition, twenty-four hours per day, seven days per week service, year-round, including holidays may be required to properly service the customers and potential customers of any large service provider, as well as to establish marketability and goodwill, particularly where the service provider is national or international in scope. One development in call processing has been menu-driven automated call processing systems. However, service providers such as truck rental facilities may have dozens or even hundreds of different service options, such as diverse geographic pick-up and drop-off locations, truck models and pricing structures. Menu-driven automated call processing as currently available is not amenable to handling a large number of options on a caller-convenient basis.

A need exists for an automated truck rental system which provides customers with many different service options in a user-friendly and convenient manner, and which is minimally labor-intensive for customized truck rentals.

The increased use of the Internet and other on-line computer-based systems has been complementing and even supplanting purely telephone-based reservation systems for service providers. Using automated servers and websites available, for example, through the World Wide Web (WWW), a service provider for truck rentals may store vast amounts of truck-related information, such as locations of facilities affiliated with the service provider as well as maps, available equipment, etc. Such information may be accessed by a potential customer at the discretion of the customer at any time, date and place. That is, the customer may inform himself/herself of the capabilities of a chosen truck rental service provider substantially on a self-help basis.

Heretofore, truck-rental websites have primarily provided rental information, while continuing to require that the customer complete the reservation on a telephone service center reservation system, typically using an 800 telephone number.

A need exists for an integrated Internet-based truck-rental reservation system which allows a customer to establish and complete a reservation on-line without requiring access to a telephone service center reservation system.

Established truck-renting companies such as “U-HAUL”, “RYDER”, “MAYFLOWER”, etc. have websites which provide information to facilitate truck rental. In particular, “U-HAUL” maintains websites such as at http://www.uhaul.com and http://emove.uhaul.com which allow a customer to enter moving departure and destination locations, the capacity of the possessions being moved, the type of trucks, and accessories desired, such as towing components, dollies and furniture pads. Quotes are provided and a reservation may be confirmed upon entry of credit card data.

However, such Internet-based truck information and rental reservation systems fail to provide expertise-based guidance for travel to affiliate locations and for adequate towing capabilities.

A need exists for an integrated Internet-based truck rental system and method which provides customers with truck-rental information and expertise-based guidance for improved truck rental and moving.

### SUMMARY OF THE INVENTION

It is an object of the present invention to provide a system and method which fulfills the above-described needs.

In achieving the above and other objects the invention provides the following.

A computer-based system and method provide truck-rental information and expertise-based guidance to facilitate a customer's reserving and renting of a truck using a communications network. The system includes a server which processes user inputs from a user's computer over a communications network and provides information responsive thereto to the user's computer over the communications network from which a service contract is generated and confirmed. The server includes a memory and programming. In the memory, a plurality of data sets is stored relating to (a) trucks which can be rented and associated rental prices for the trucks, (b) towing accessories that can be rented and towed vehicles with which the towing accessories can be used, (c) towing accessories and associated rental prices for the towing accessories, (d) expertise-based guidance relating to trucks, and (e) expertise-based guidance relating to towing accessories. The programming responds to user inputs to access the memory and provide data from respective data sets to user computer over the communications network.

In a computer-based system for renting trucks, the improvement of a memory in which is stored a data set relating to towing accessories that can be rented and towed vehicles with which the towing accessories can be used, and programming which responds to a user input identifying a vehicle to be towed which accesses the memory and provides to the user computer over the communications network data indicating availability or not of a towed accessory for the identified vehicle to be towed in accordance with the data set.

Alternatively or in addition, in a computer-based system for renting trucks, the improvement of a memory in which is stored a data set relating to vehicle pick-up and drop-off locations and programming responsive to a user input identifying a geographical location in which the vehicle is to be picked up and a geographical location in which the vehicle is to be dropped off which accesses the memory and provides to the user computer over the communications network data indicating at least two locations closest to the geographic location input for pick-up and at least two locations nearest to the geographic location input for drop-off.

One or more of the above systems includes a payment-processing subsystem for establishing payment arrangements with the user in response to user inputs providing payment data communicated to the server over the communications network. In one embodiment, the memory stores a data set relating to discounts available to qualified users, and the server responds to user inputs providing data relating to discount eligibility, and provides a quote for rental of a selected truck including a discount corresponding to the user inputted discount eligibility data.

In a preferred embodiment of a computer-based system for renting trucks, the communications network is the Internet and the programming provides the data to the user computer in the context of one or more web pages. The server responds to user inputs corresponding to truck selection, pick-up and drop-off locations, and a pickup date, and generates a service contract data set, including a quote for the truck rental, associated with the user to be provided to the user's computer over the communications network. The user inputs may include a selection of moving accessories, and the server generates the service contract data set associated with the user and including the costs for the accessories in the quote for the truck rental. Alternatively, the user inputs may include a reservation confirmation command; and the server responds to the reservation confirmation command, and generates a confirmation message to be provided to the user's computer through the communications interface.

In another embodiment an Internet-based system is provided for aiding users to create and confirm reservations for truck rentals. This system includes a web server and a backend server, with the web server providing a plurality of web pages accessible through the Internet and for processing user inputs received through the Internet from a user's computer operating an Internet browser displaying the plurality of web pages. At least one web page has at least one input field for receiving the user inputs. The backend server operatively connected to the web server and responsive to the user inputs, and includes a memory and at least one program module. The memory stores the plurality of web pages, stores truck-related information in a database, and stores user-generated reservation information. The at least one program modules process the user inputs and the truck-related information to determine and display to the user a set of closest locations associated with a departure location and a destination location specified by the user, to access and display directions from a user-specified address to the departure and destination locations, to generate towing guide information corresponding to a user-specified vehicle to be towed by the rented truck, to generate and display a quote for the truck rental corresponding to the user inputs, for processing payment information provided by the user. The at least one program module generates the reservation information from the user inputs, and confirms the reservation to the user with a confirmation message. In the Internet-based system, the at least one program module responds to modifications of the user inputs prior to confirmation of the reservation to modify the reservation information.

In another embodiment of an Internet-based system for aiding users to create and confirm reservations for truck rentals, a web server provides a plurality of web pages accessible through the Internet and processes user inputs received through the Internet from a user's computer operating an Internet browser displaying the plurality of web pages which include at least one input field for receiving the user inputs. In this embodiment, an improvement is provided that includes a web page including data fields providing all information which the system provides to a user necessary for a service contract in response either to user input data or data available from the system. In this web page all data fields may be modified on the web page by the user without having to revert to another web page.

A computer-based method for truck rentals is also provided, having the steps of providing expertise guidance to a user for selecting trucks which can be rented; providing expertise guidance to a user for selecting towing accessories that can be rented for a particular vehicle to be towed; in response to user input, providing pricing information for a selected truck; in response to user input, indicating whether a towing accessory is available for the user input information responsive to the towing accessory expertise guidance; and if a towing accessory is available, providing pricing information for the available towing accessory.

In a computer-based method for truck rentals which provides truck availability and pricing information, the invention provides the improvement of providing towed vehicle identification data to the user, receiving a towed vehicle selection, determining whether an accessory is available for the particular selected vehicle, and informing the user of the result of the determination. Alternatively or in addition, the improvement includes the steps of receiving user information which a user provides as part of the process of requesting a reservation for a vehicle identifying a vehicle pick-up location and a vehicle drop-off location, and providing the user with information identifying at least two locations closest to the vehicle pick-up location and at least two locations nearest to the vehicle drop-off location input by the user.

Alternatively or in addition, the improvement also includes the step of generating a reservation form on a web page which conations all reservation information provided in response to user input which may be changed by the user directly on the form on that web page without having to access another web page.

A method is also provided for facilitating truck rentals having the steps of providing a plurality of web pages accessible to a user through the Internet, at least one web page including a form for receiving user inputs; storing in a memory truck-related information including types of trucks and associate rental prices; storing in the memory expertise-based information, including vehicle-specific towing requirements and directions to respective locations of truck rental affiliates; and processing user inputs with a server using the truck-related information and the expertise-related information to assist the user to generate and confirm a service contract to rent a selected truck.

The expertise-based information includes a table of vehicle towing information, and, in the method, the step of processing includes the steps of receiving user-input selections of equipment including a selection of a truck for rental and a selection of a vehicle type for towing by the selected truck; accessing the vehicle towing table to determine if the selected vehicle is capable of being towed by the selected truck; and generating a towing advice indication for display to the user whether the selected truck is appropriate for towing the selected vehicle.

The expertise-based information may include an affiliate table of truck-rental affiliates including geographic locations and a direction table storing travel directions to the affiliates, and the step of processing includes the steps of receiving user-inputs corresponding to a departure location and a destination location; accessing the affiliate table to determine the closest affiliates to the departure and destination locations, respectively; accessing travel directions for the closest affiliates; and providing the travel directions for display to the user. The server includes a payment-processing sub-system; and the processing step includes the steps of receiving user inputs corresponding to payment information, and establishing payment arrangements with the customer corresponding to the user inputs.

The payment-processing sub-system includes credit-card processors, and the user inputs include credit card information. The user inputs indicate discount eligibility, and the processing step includes the steps of generating a quote for rental of a selected truck from the user-accessible data sets, and adjusting the quote using a discount corresponding to the user inputted discount eligibility. The user inputs correspond to truck selection, departure and destination locations, and a pickup date, and the processing steps includes the steps of generating a service contract data set, including a quote for the truck rental, associated with the user.

The user inputs may also include a selection of moving accessories, and the step of generating the service contract data set includes the step of adding the costs for the accessories in the quote for the truck rental. The user inputs may also include a reservation confirmation command, and the step of processing includes the steps of receiving the reservation confirmation command, and generating a confirmation message to be provided to the user.

### BRIEF DESCRIPTION OF THE DRAWINGS

FIG. 1 illustrates a schematic of the disclosed truck rental system;

FIGS. 2-7 illustrate a flowchart of operation of the system of FIG. 1;

FIG. 8 illustrates an initial webpage to access the system of FIG. 1;

FIGS. 9-10 illustrate input forms for receiving user information;

FIG. 11 illustrates a webpage listing the closest truck rental affiliates to the departure and destination locations;

FIGS. 12-13 illustrate directions and hours of operation of the closest affiliates selected by the user;

FIGS. 14-15 illustrate initial reservation webpages;

FIGS. 16-17 illustrate a webpage for inputting payment information;

FIGS. 18-19 illustrate reservation confirmation webpages;

FIG. 20 illustrates a supplemental information webpage;

FIGS. 21-27 illustrate information screens for guiding a customer in towing a car;

FIGS. 28A-28B illustrate records and fields for storing rate table information;

FIGS. 29A-29C illustrate records and fields for storing rate table details;

FIG. 30 illustrates a data structure for storing information for a towability guide;

FIGS. 31A-31C illustrate sample towability records for specific vehicles;

FIG. 32 illustrates data codes and comments for providing towability advice;

FIGS. 33A-33B illustrate a data structure for storing tracking quote information;

FIGS. 34A-34B illustrate sample records for tracking quotes;

FIG. 35 illustrates a data structure for storing rates for accessories;

FIG. 36 illustrates a sample record for rates for accessories;

FIGS. 37A-37E illustrate data structures for storing booked reservations; and

FIGS. 38A-38F illustrate a sample record of a booked reservation.

### DETAILED DESCRIPTION OF THE PREFERRED EMBODIMENT

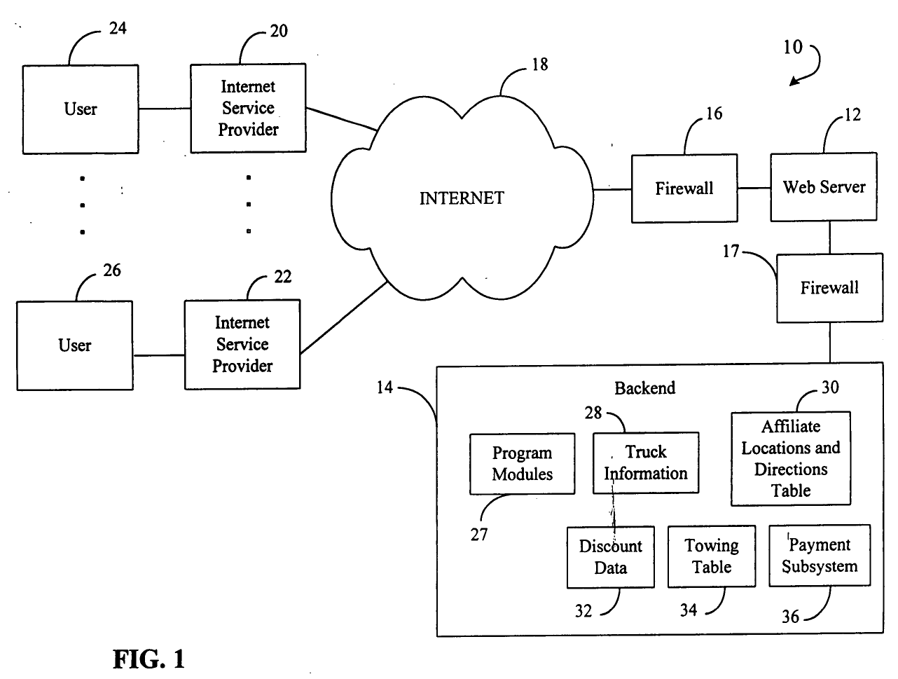

Referring to FIG. 1, a computer-based system 10 and method of use provide truck-rental information and expertise-based guidance to facilitate a customer's self-actuated rental and reservation of a truck. The computer-based system 10 includes a server for processing user inputs from a user's computer to provide expert-based guidance to assist the user to generate and confirm a service contract to rent a selected truck. The server includes a communications interface to the user's computer, and a memory for storing a plurality of user-accessible data sets of truck-related information including types of trucks and associate rental prices, and for storing a plurality of expertise-based data sets. The server responds to the user inputs by accessing a respective data set corresponding to the user inputs and transfers the respective data set through the communications interface to the user's computer. The server also responds to user inputs by generating expertise-based guidance to facilitate the generation and confirmation of the service contract.

In a preferred embodiment, the server may be a web server 12 connected to a backend 14, such as an AS/400 server, and so the communications interface in the web server 12 may be operatively connected to the Internet 18 and to the backend 14 through firewalls 16, 17, for example, using an Internet communications protocol to connect to the Internet 18 and thence through Internet service providers (ISPs) 20-22 to respective web browsers of each computer associated with each respective user 24, 26.

The backend 14 includes a plurality of program modules 27 for processing user inputs and for accessing a memory storing a plurality of data sets relating to (a) trucks which can be rented and associated rental prices for the trucks, (b) towing accessories that can be rented and towed vehicles with which the towing accessories can be used, (c) towing accessories and associated rental prices for the towing accessories, (d) expertise-based guidance relating to trucks, and (e) expertise-based guidance relating to towing accessories. A first program module may access rental rate information, which may be stored as a portion of the truck information 28 in a relational database including approximately 51,000 headers and over 4 million detail records, for storing truck types, sizes, and costs for rental. The first program module may also access the information on the towability of a vehicle from a towing table 34, and the rates of a tow dolly and car carrier, as required, as well as rates for insurance such as limited damage waiver (LDW) information and personal accident/cargo insurance (PAI) stored in the truck information 28 or other tables and databases stored in the memory of the backend 14.

A second program module is provided to access accessory price information stored in the memory, for example, for hand trucks, furniture pads, and boxes. A third program module is used to access tax information stored in the memory, for example, to calculate applicable taxes in the rental reservation quotes and calculations for various states and municipalities. A fourth program module accesses the discount data based on the user selections and inputs as well as the calculations determined from the other program modules.

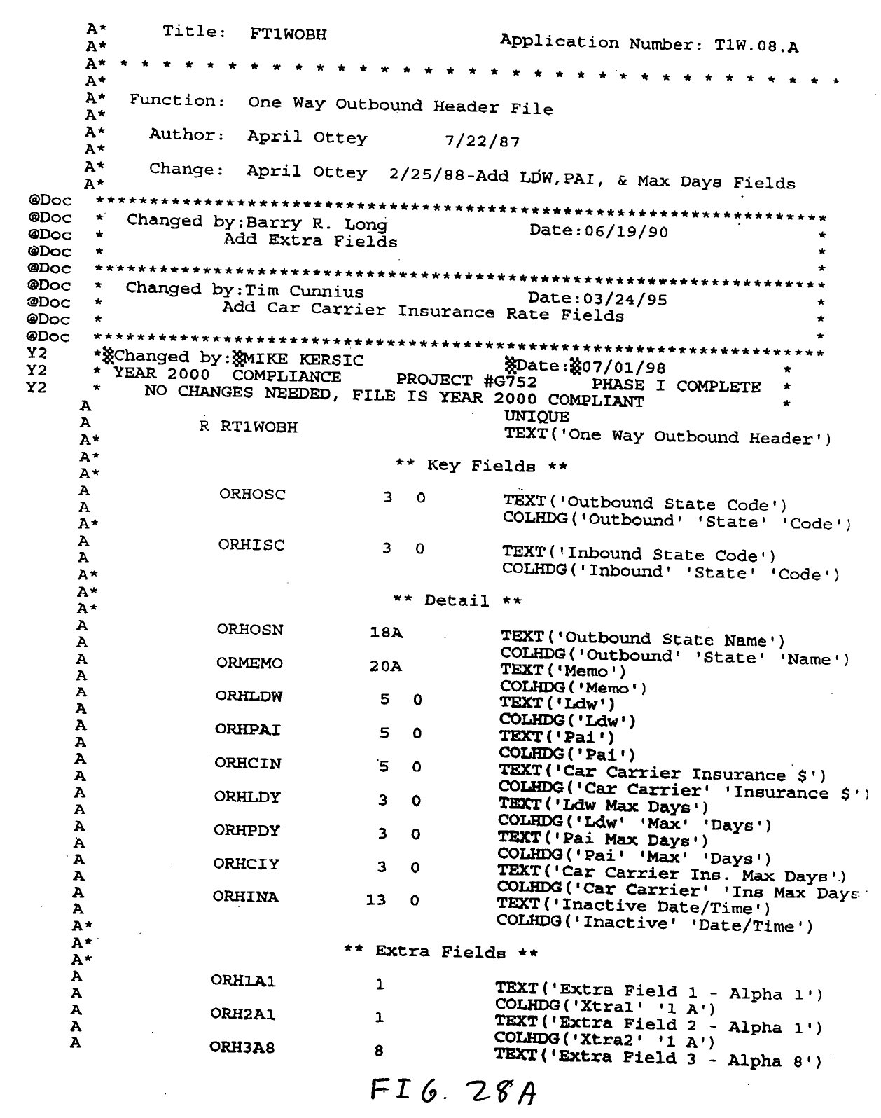

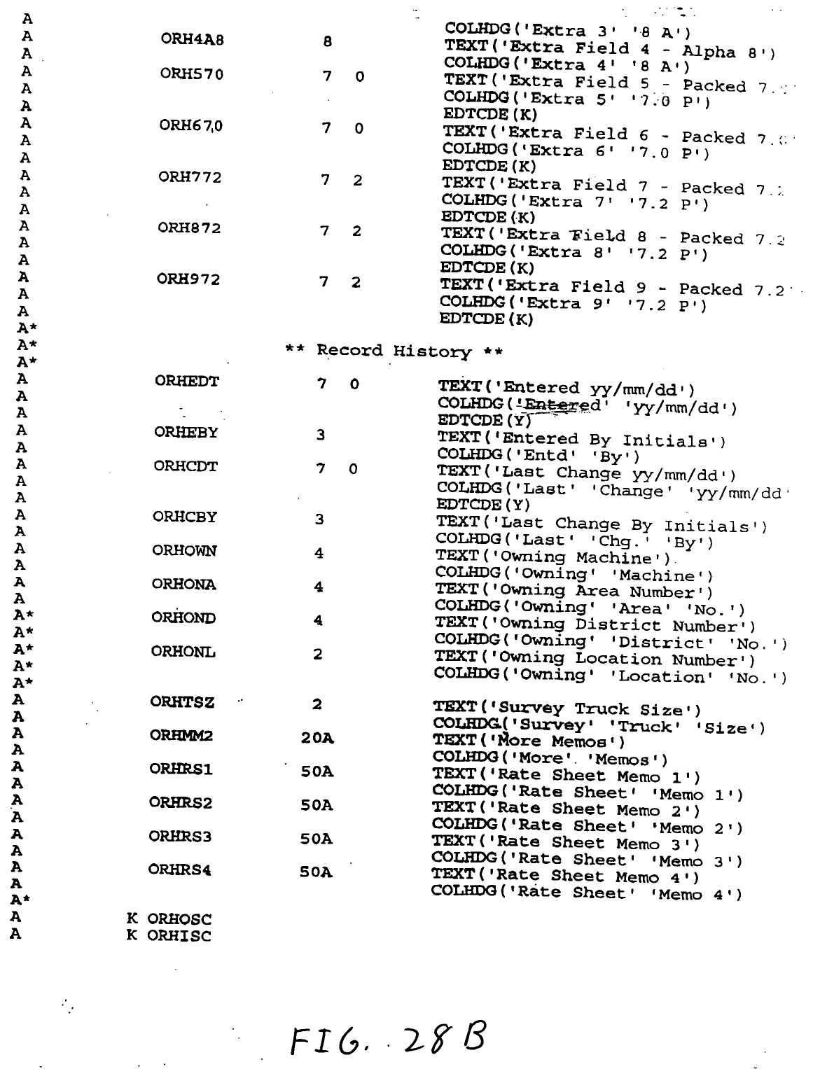

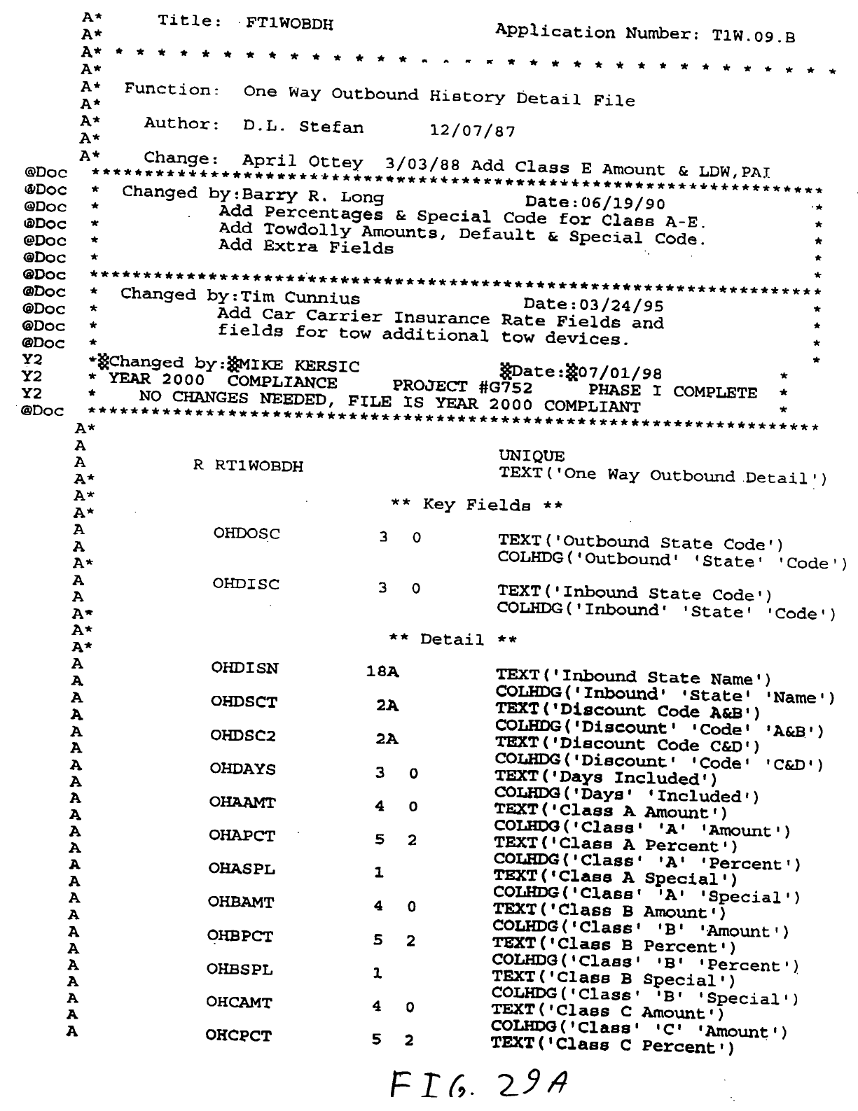

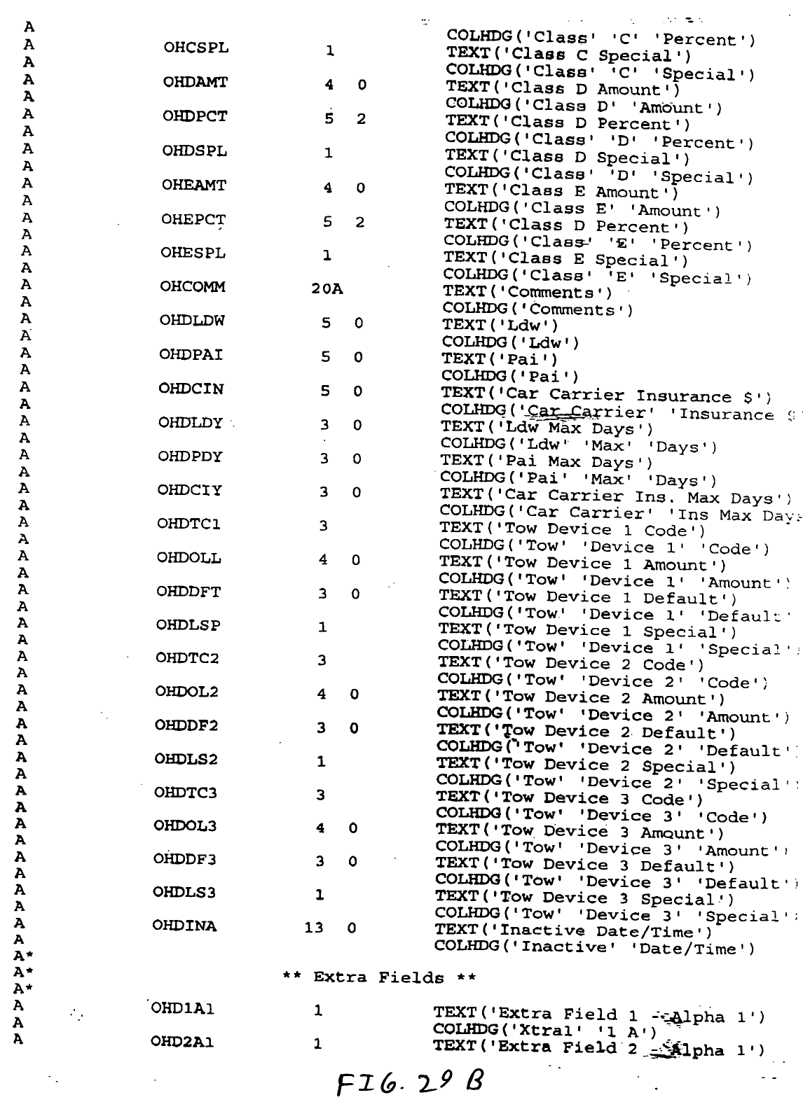

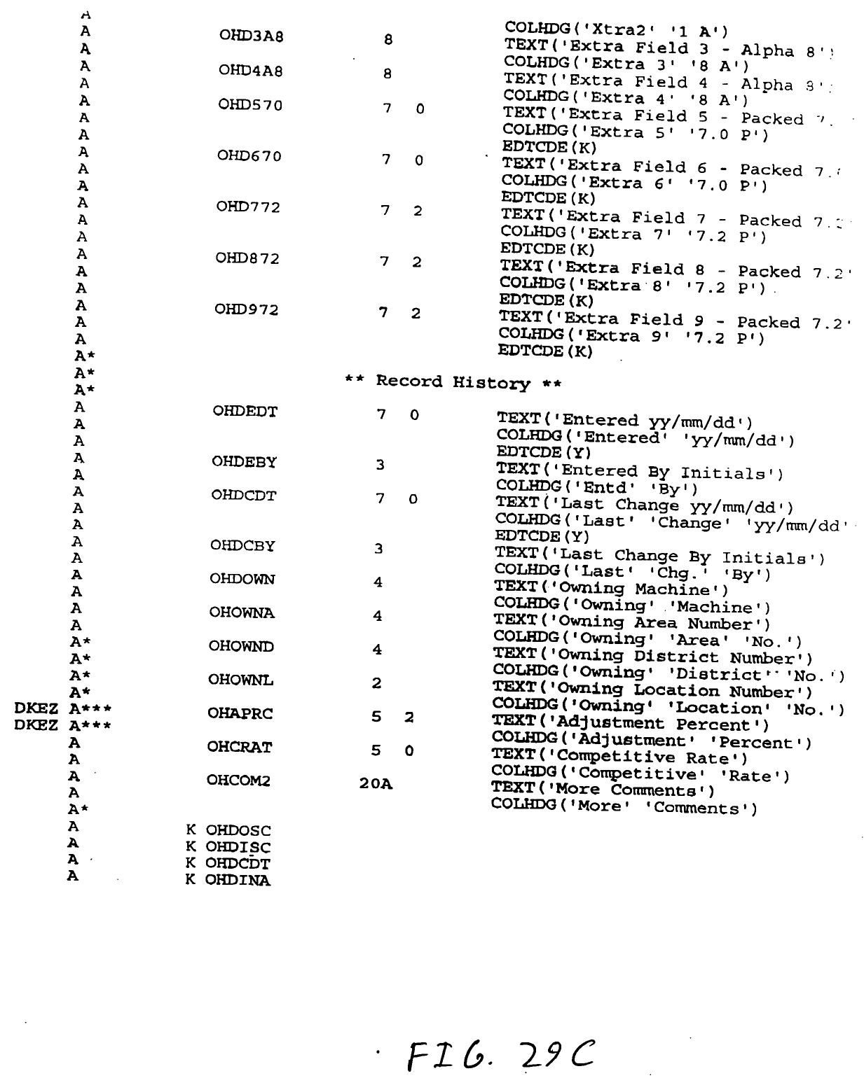

For example, the truck information 28 stored in the memory may include rate table information having data structures, as shown in FIGS. 28A-28B, for maintaining rate table details as shown in FIGS. 29A-29C.

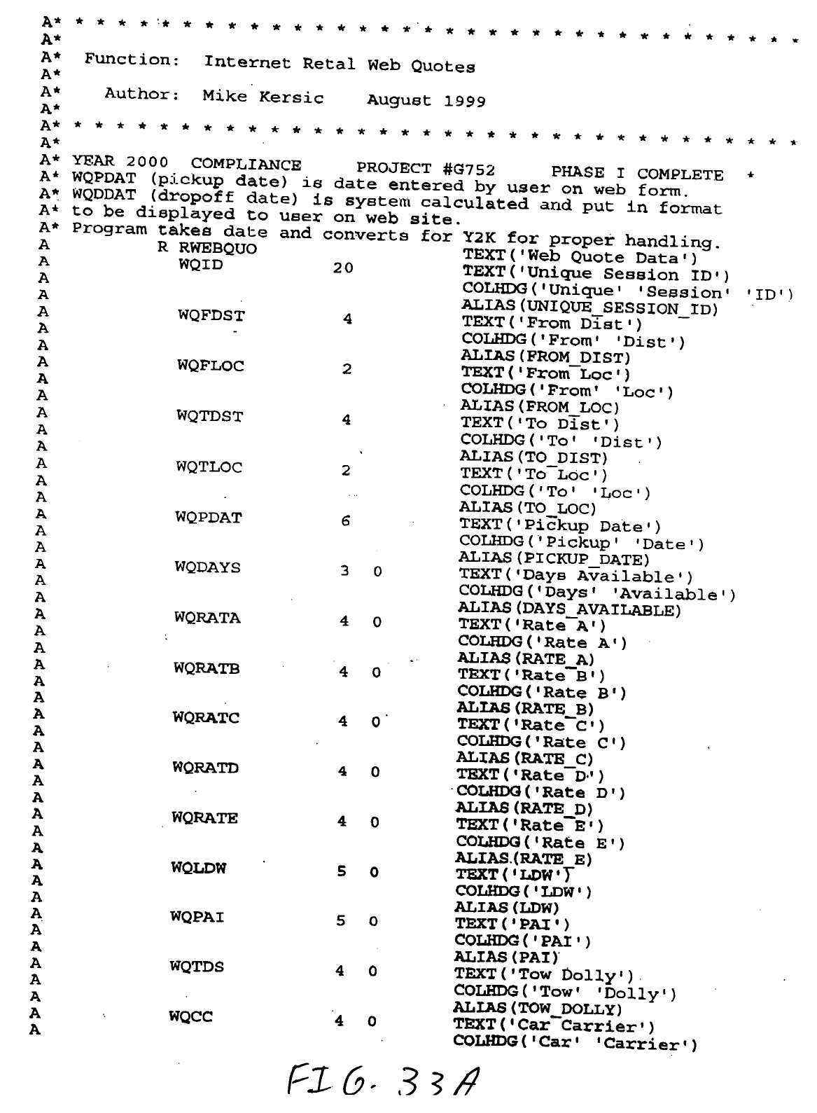

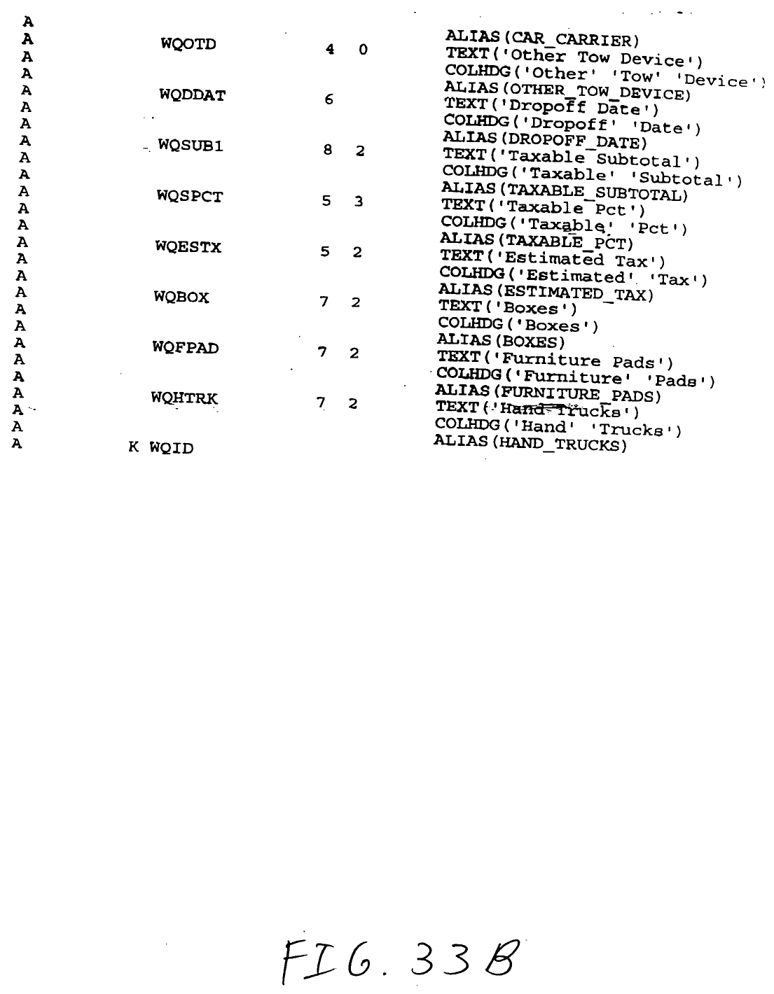

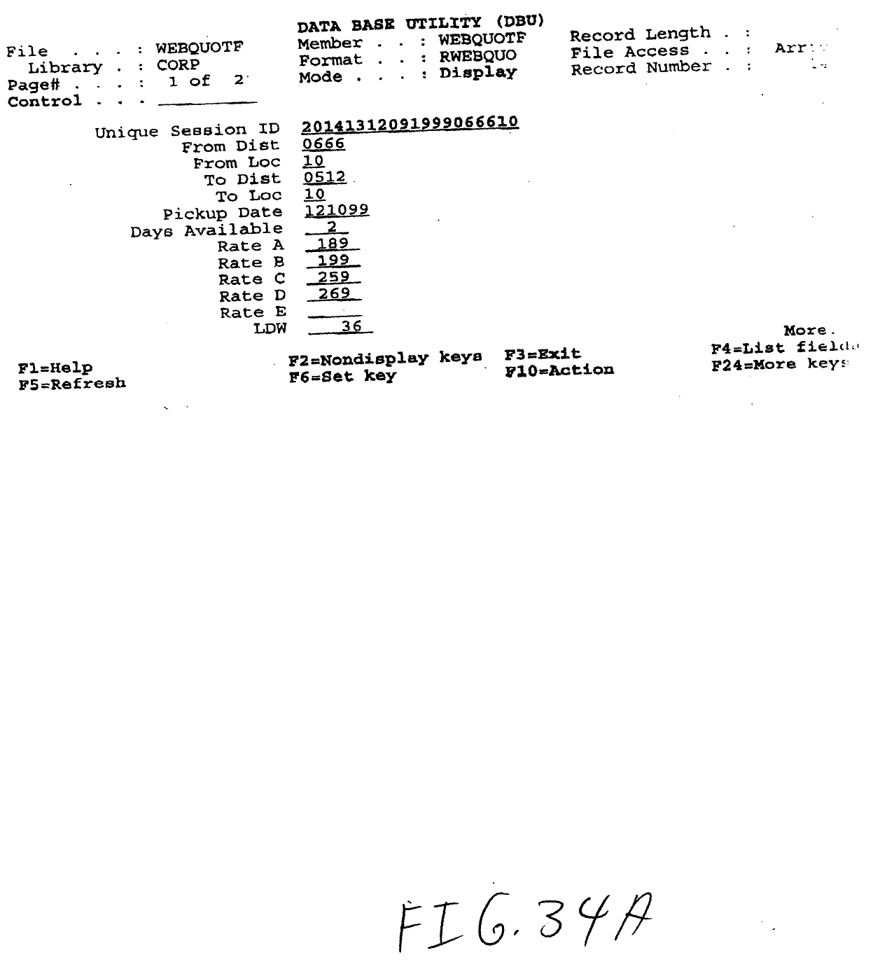

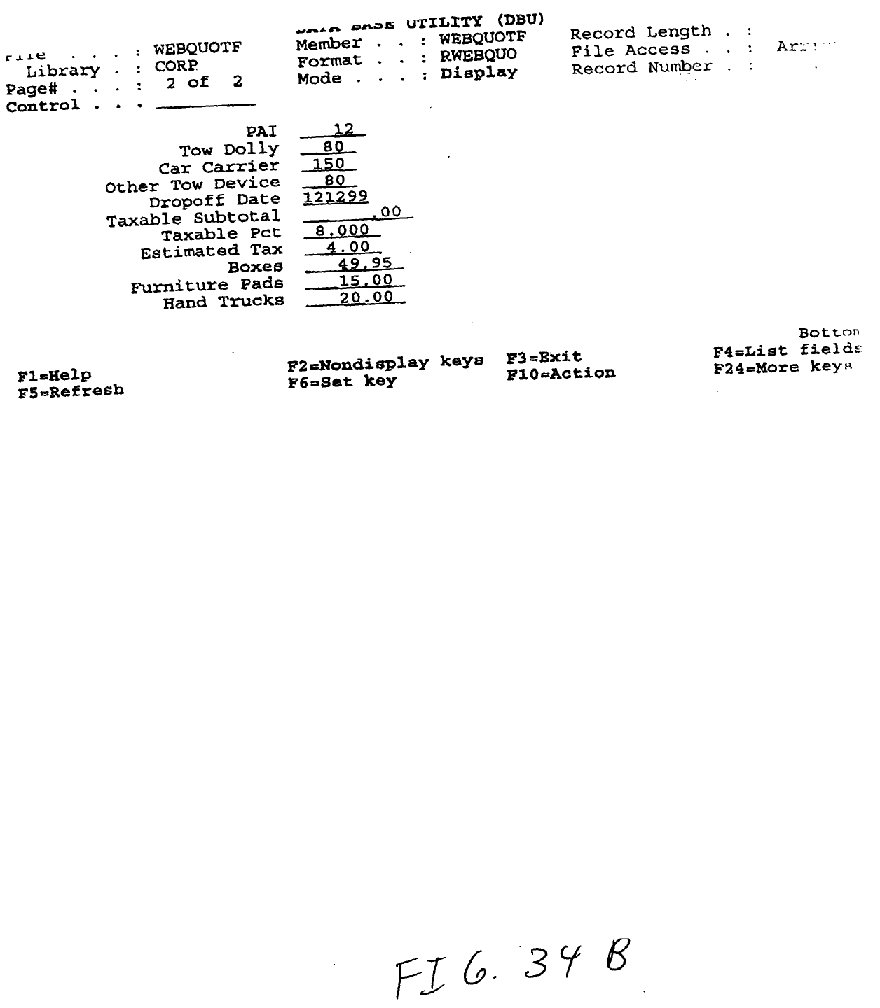

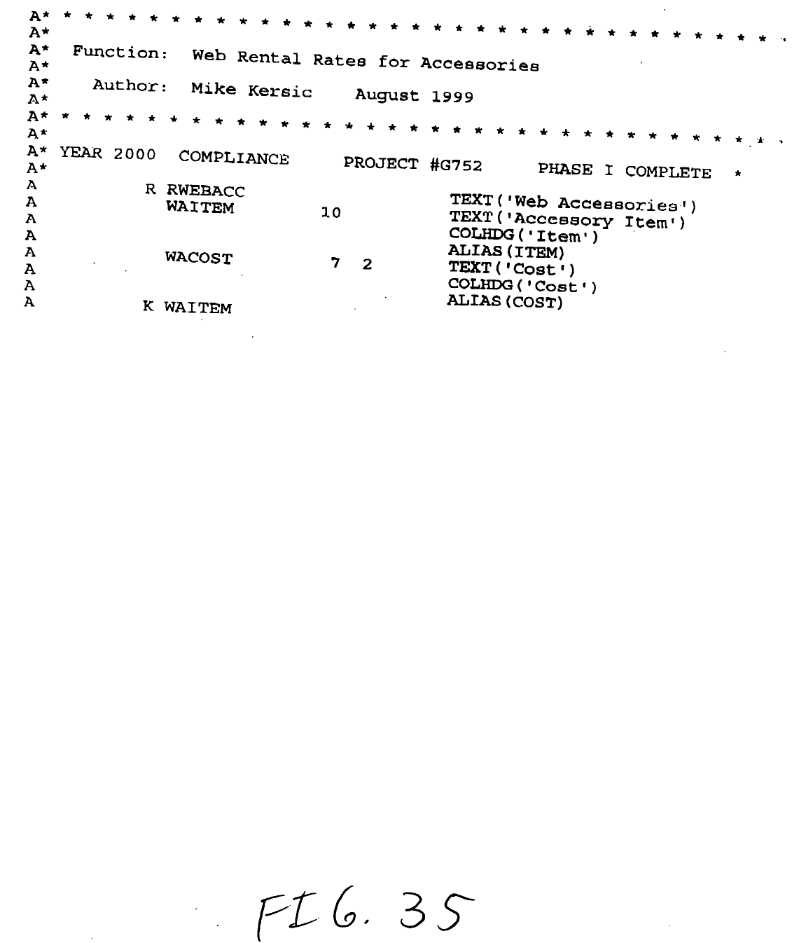

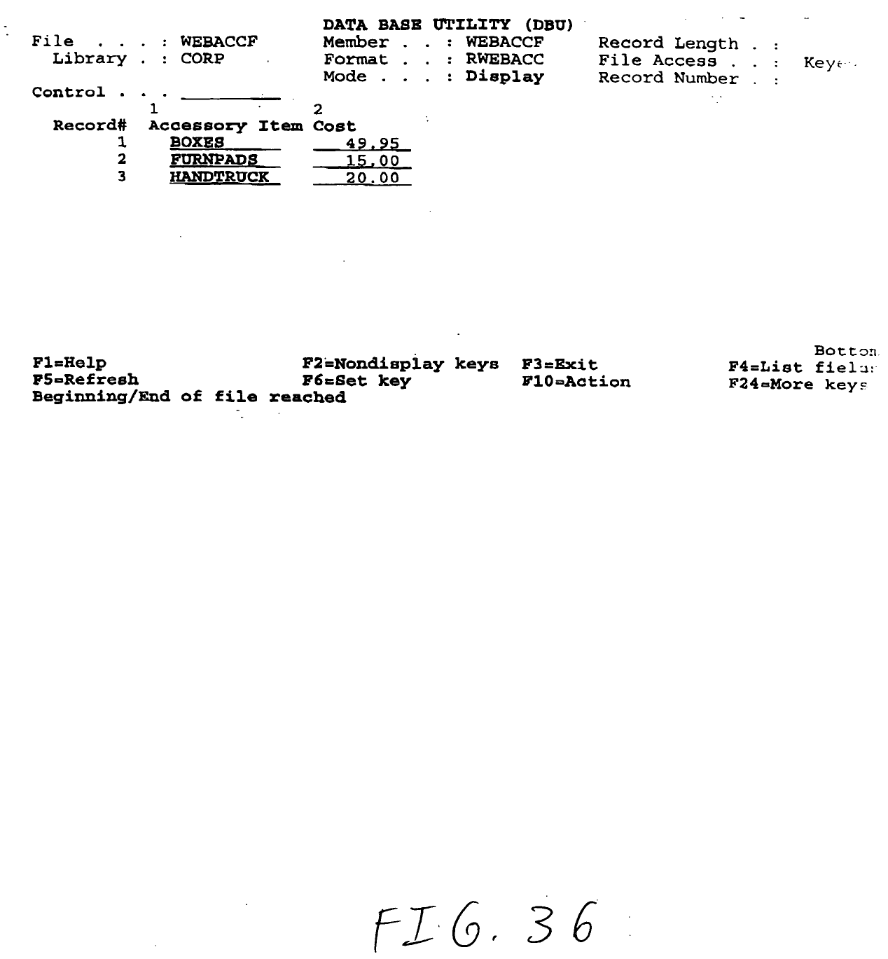

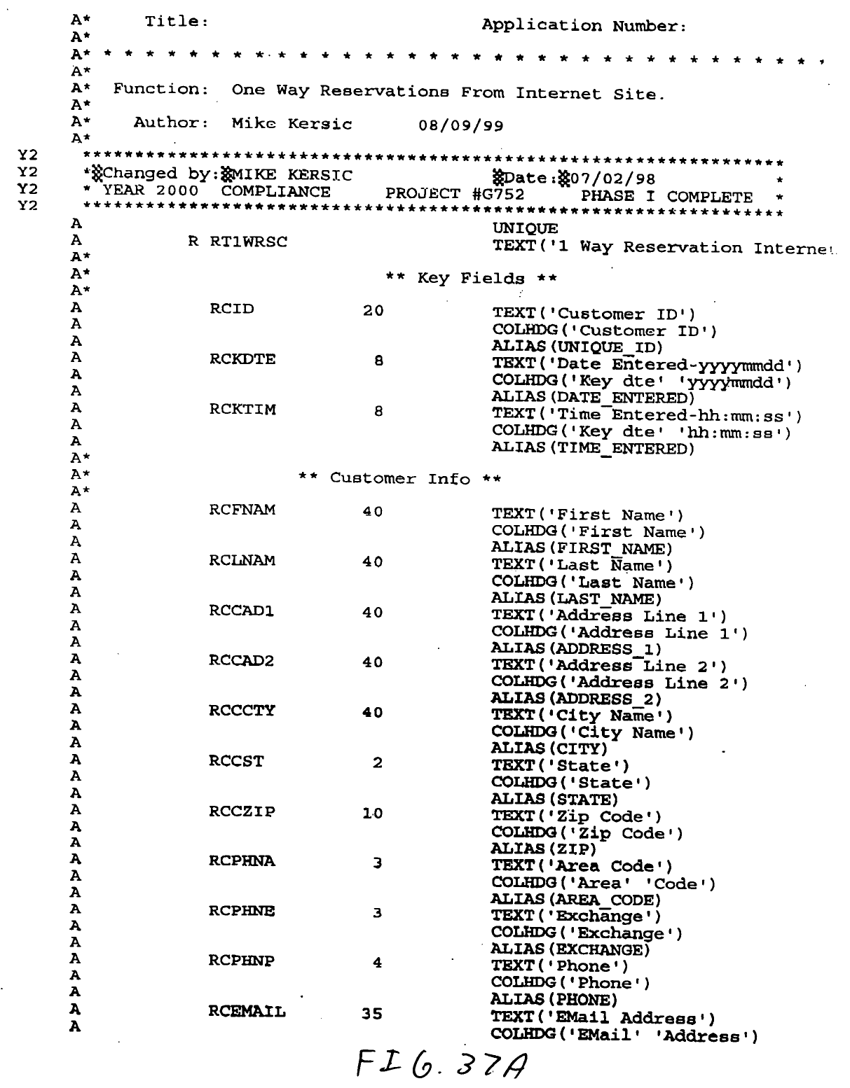

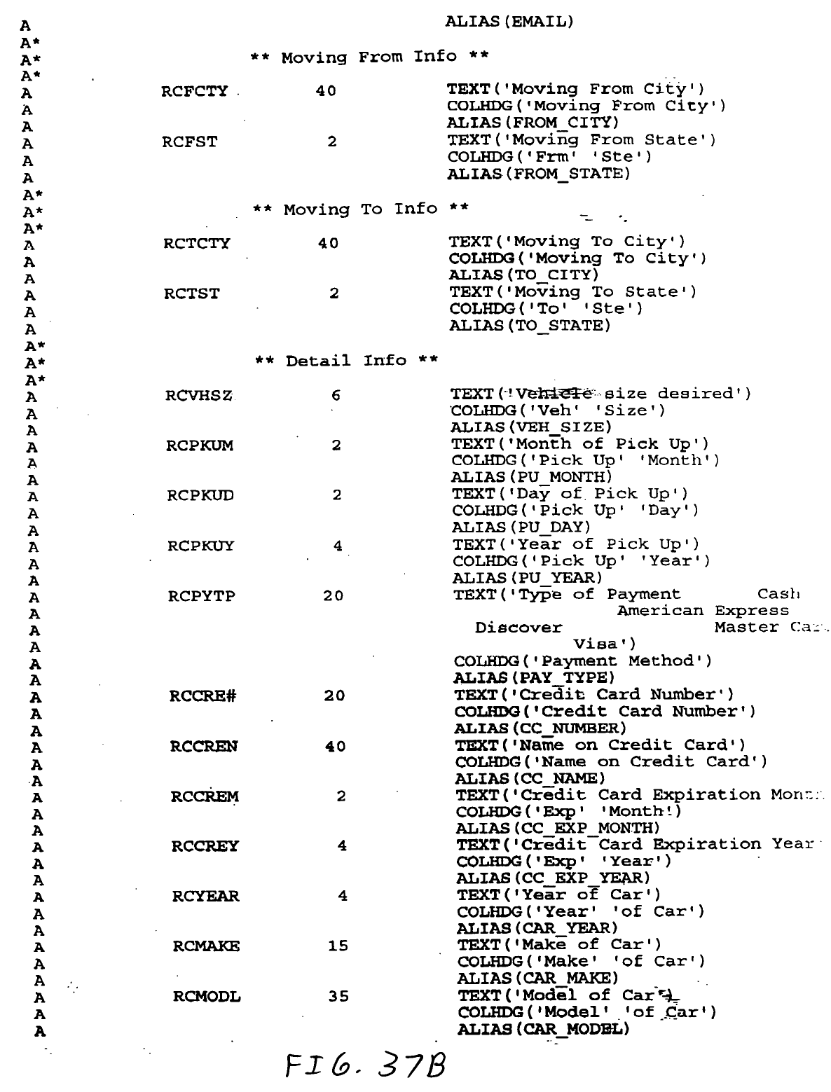

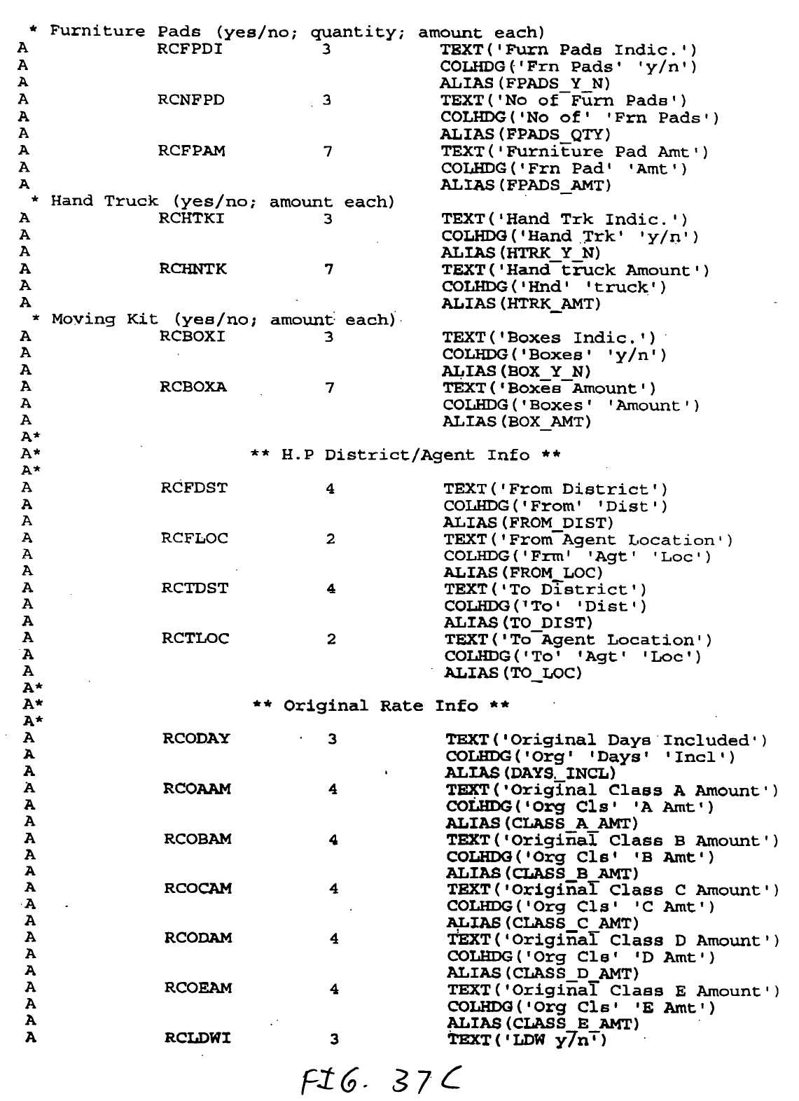

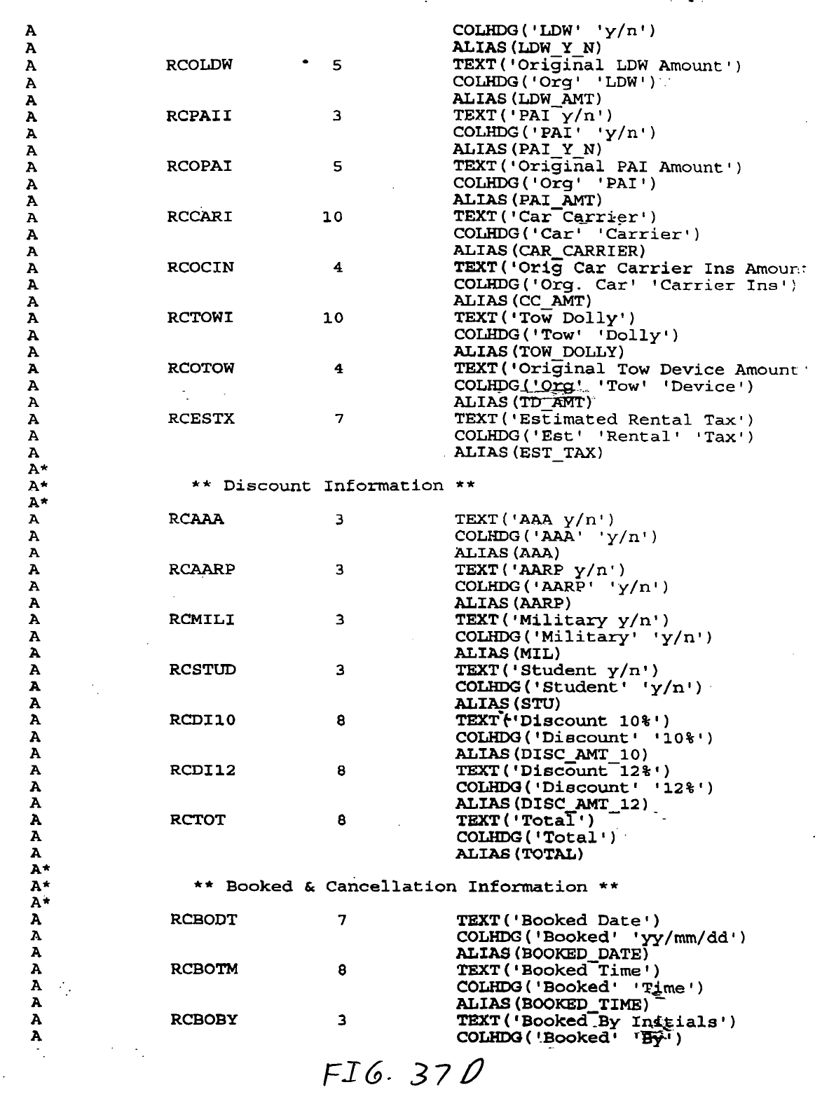

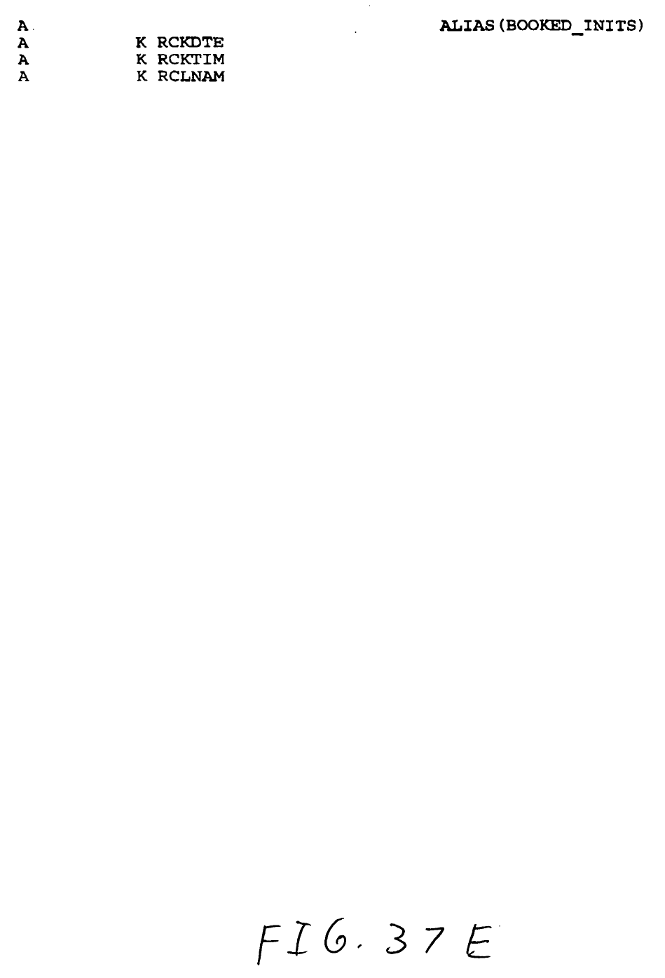

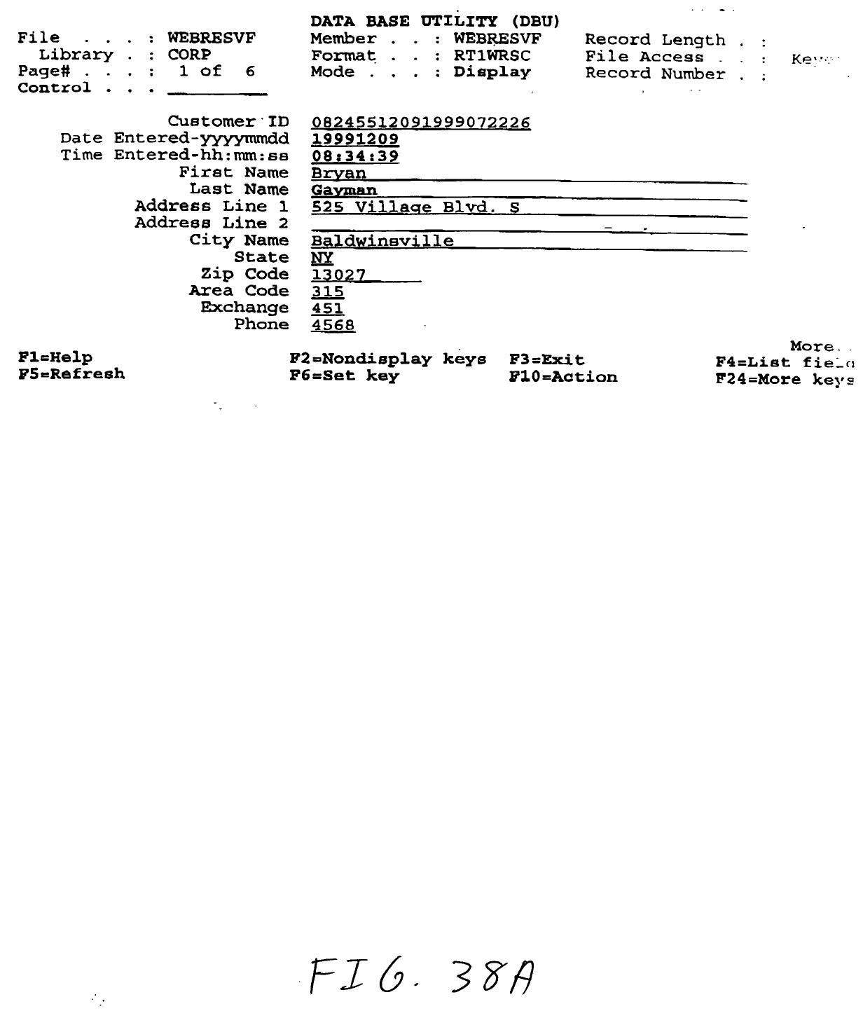

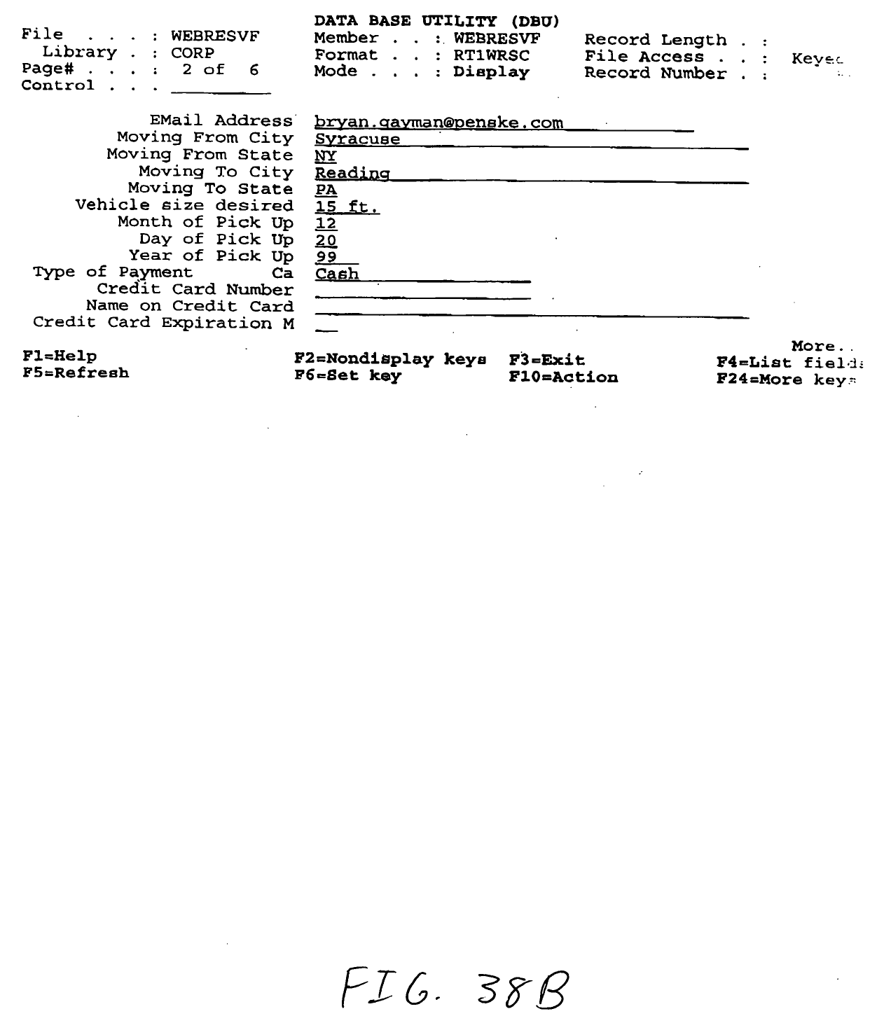

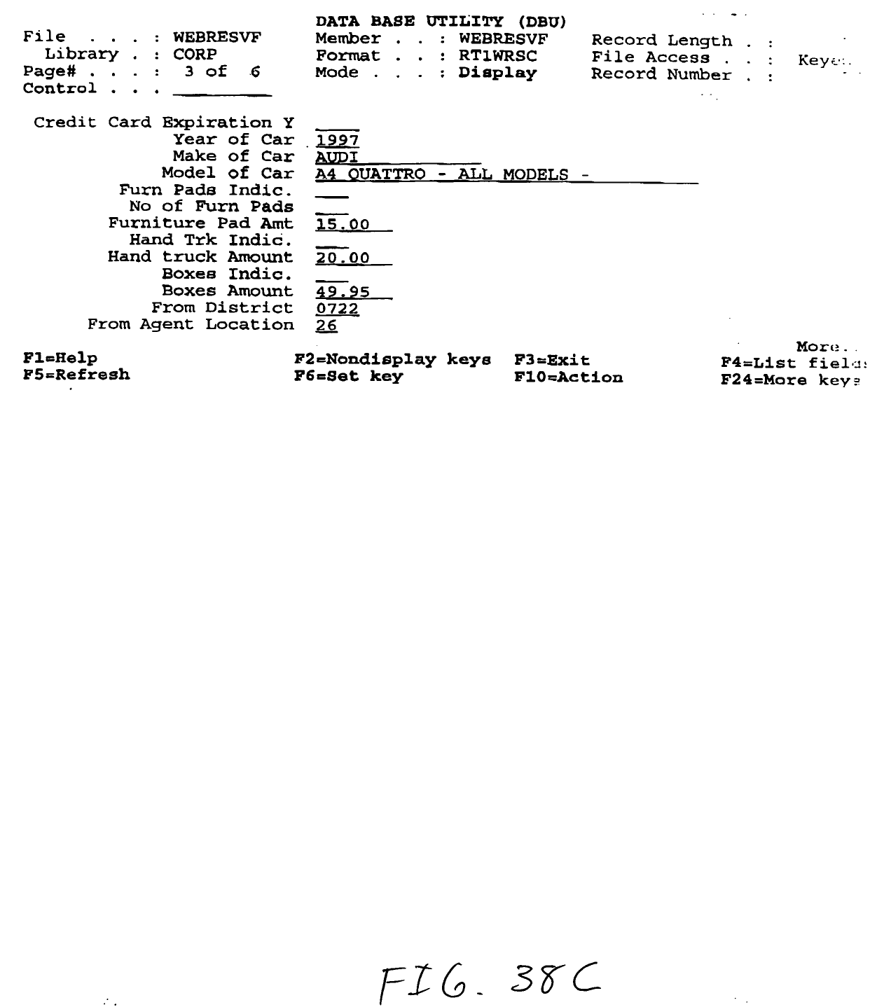

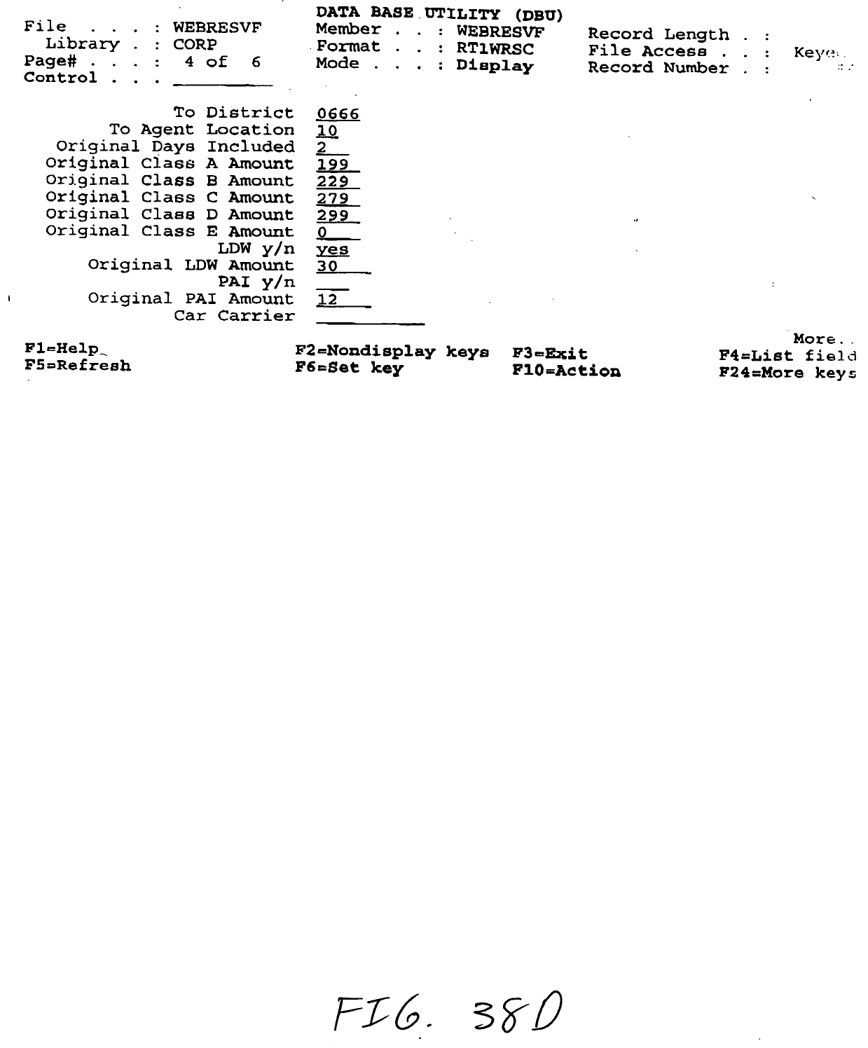

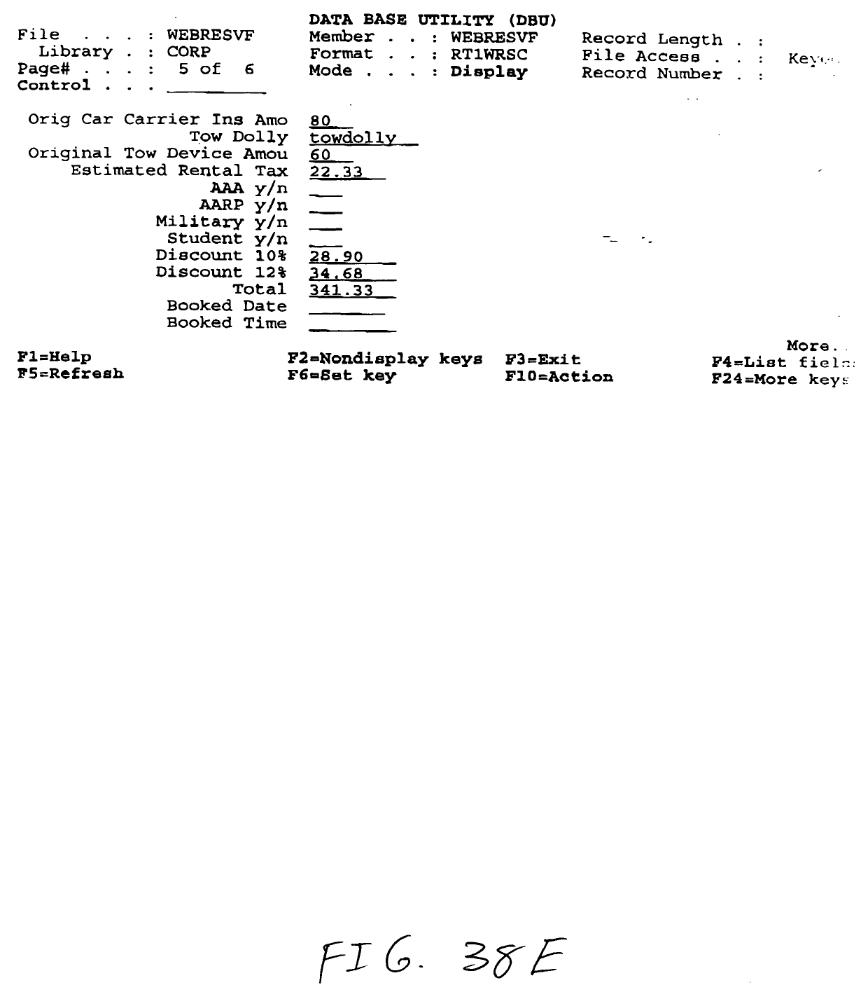

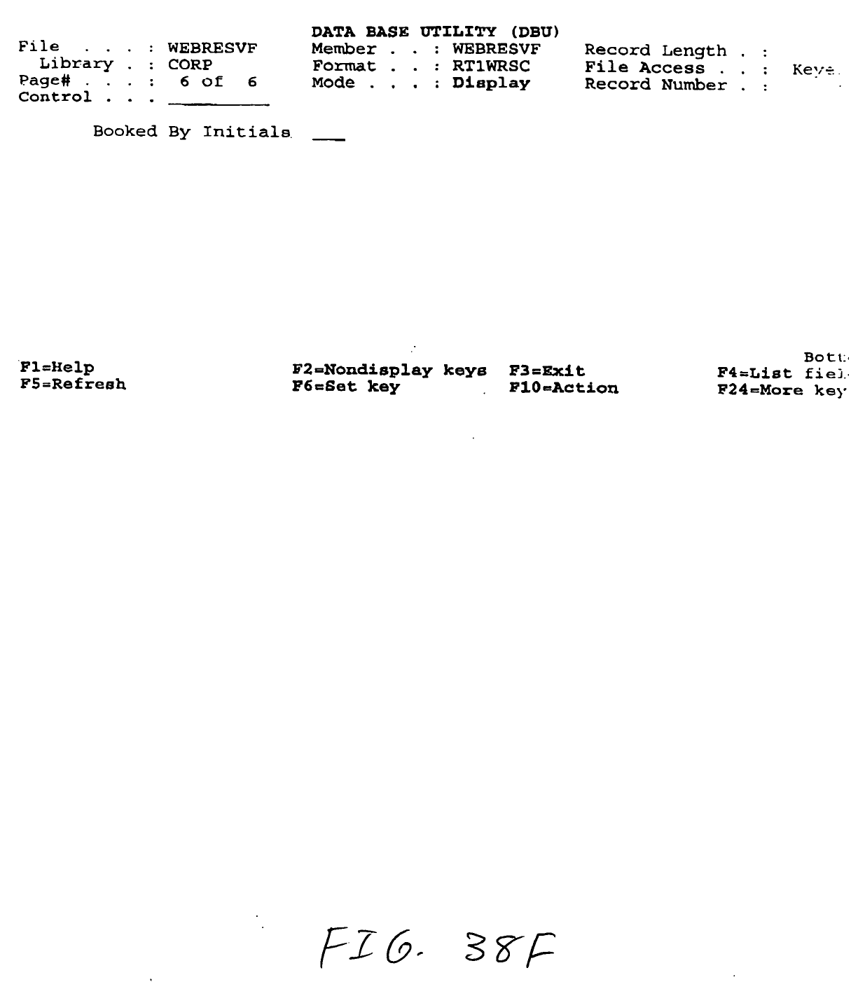

Other tables and databases may be stored in memory by the backend 14, for example, in the truck information 28. For example, FIGS. 33A-33B illustrate a data structure for storing tracking quote information, and FIGS. 34A-34B illustrate sample records for tracking quotes using the data structures of FIGS. 33A-33B. Rate information may be stored in data structures, such as the data structures shown in FIG. 35 for storing rates for accessories. FIG. 36 illustrates a sample record for rates for accessories using the data structure of FIG. 35. Customer identification and reservation tables and databases may also be stored in the memory, for example, using the data structures shown in FIGS. 37A-37F for storing booked reservations in the form of customer records, such as the sample record shown in FIGS. 38A-38F illustrating a sample record of a booked reservation.

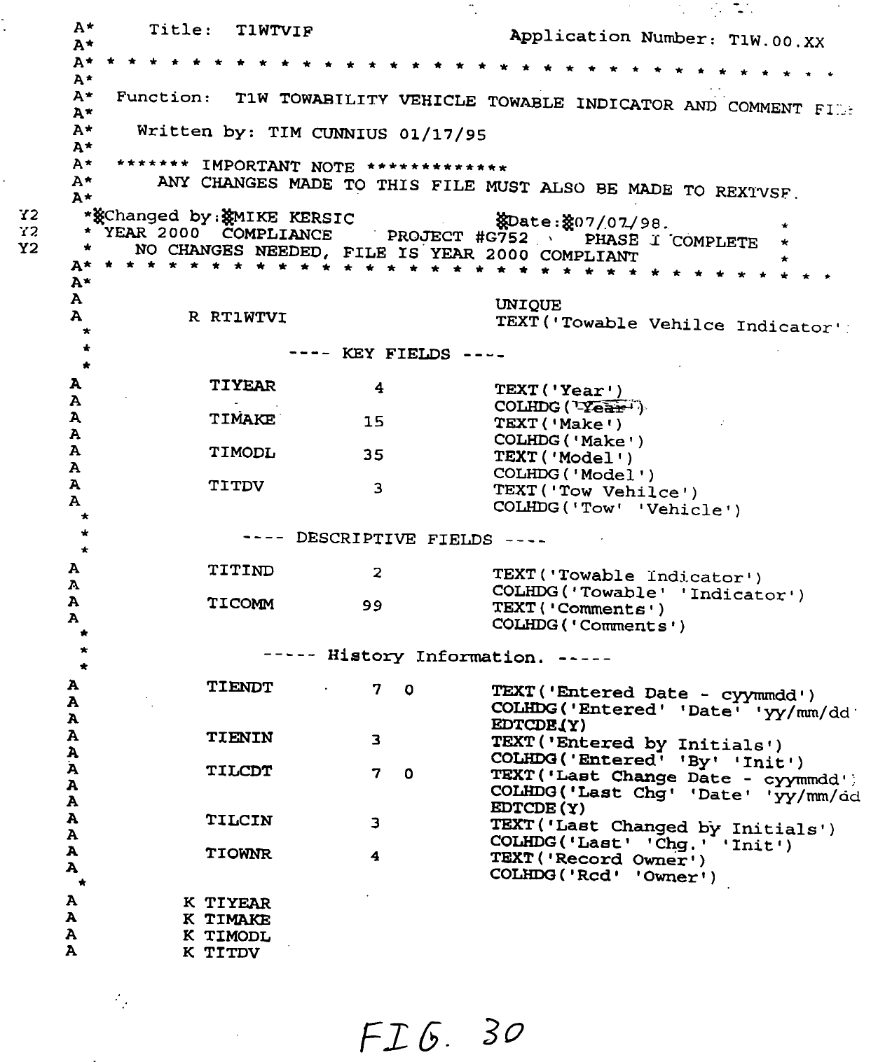

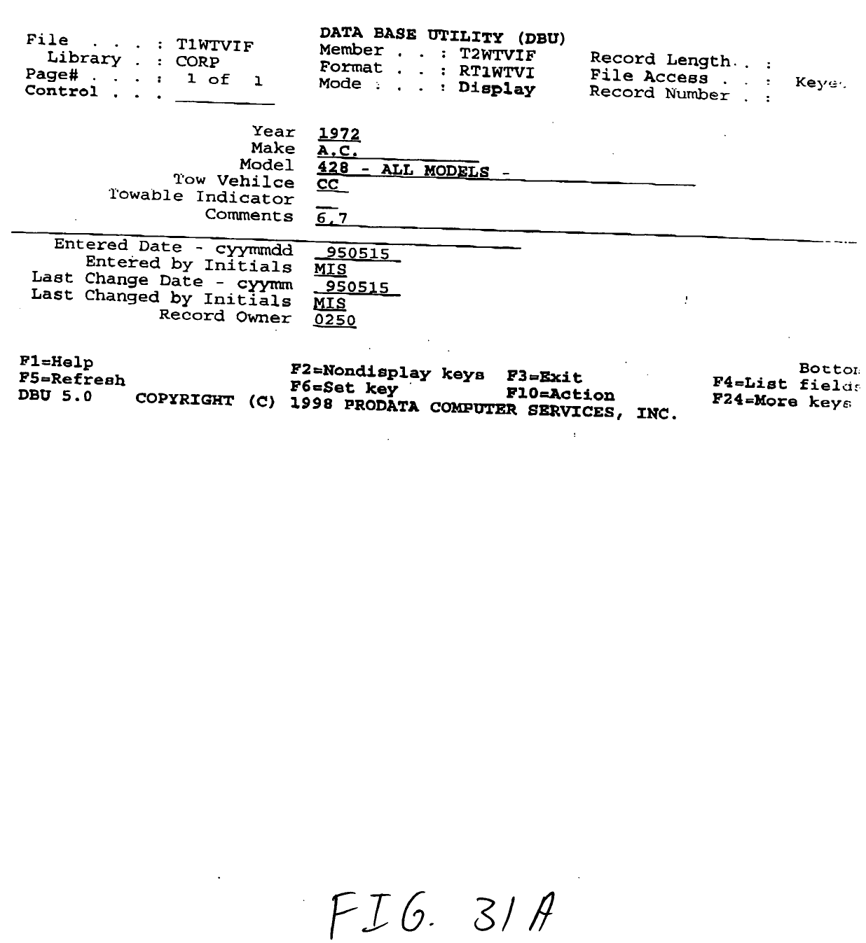

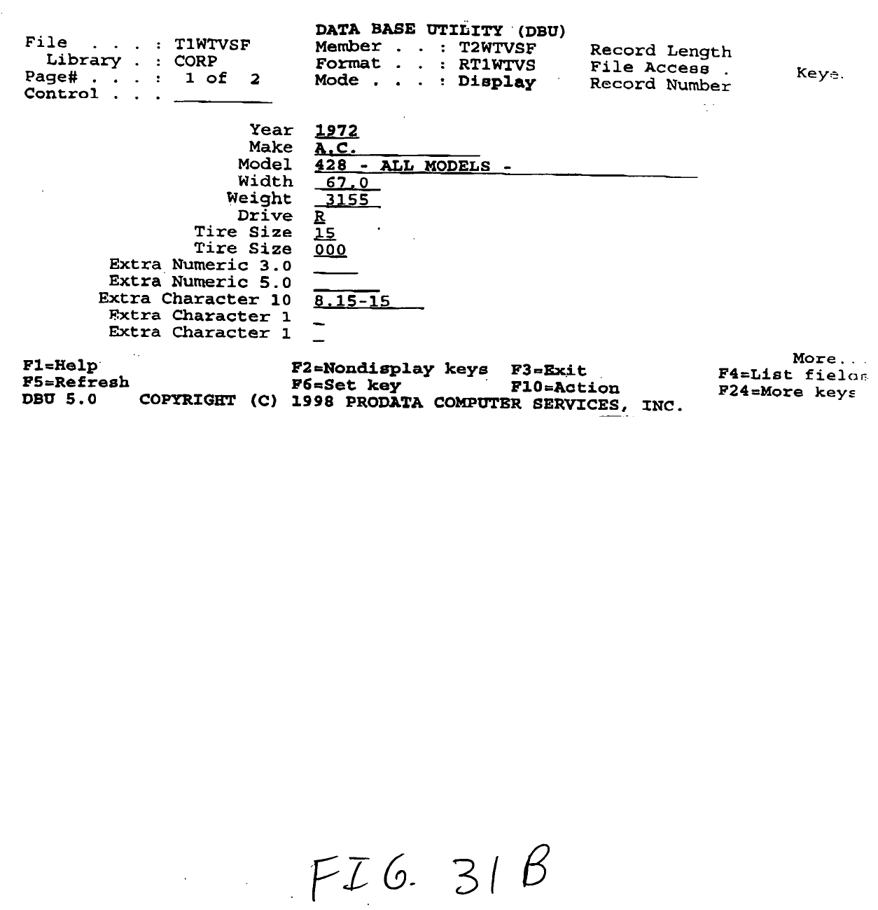

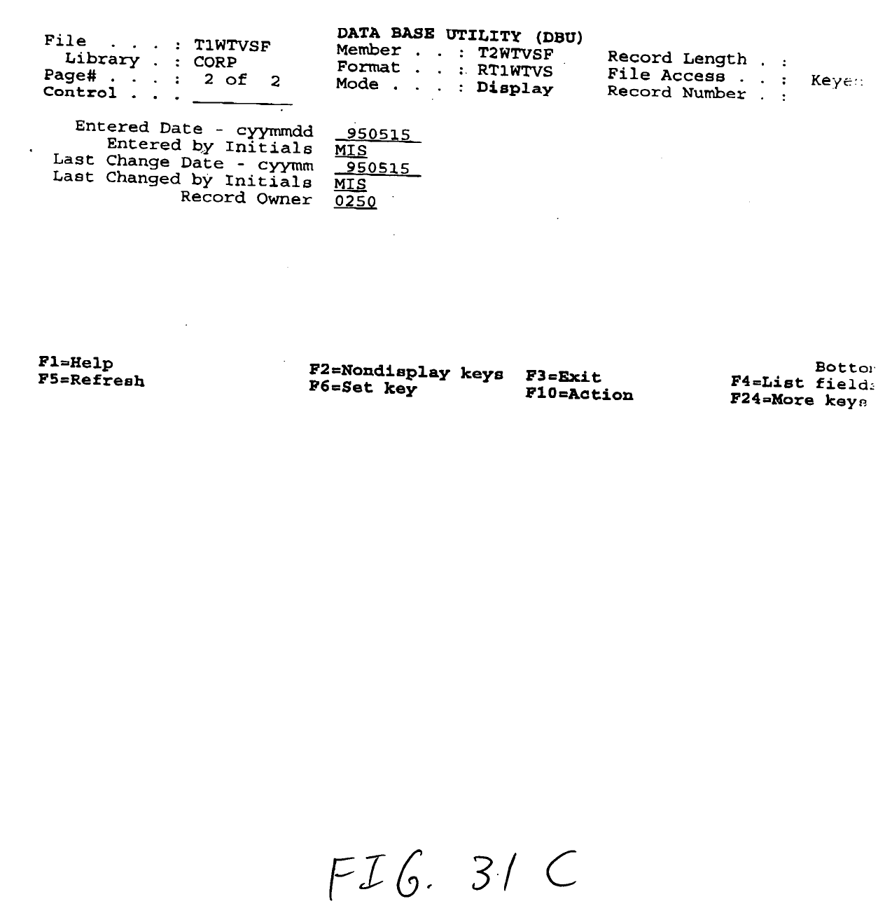

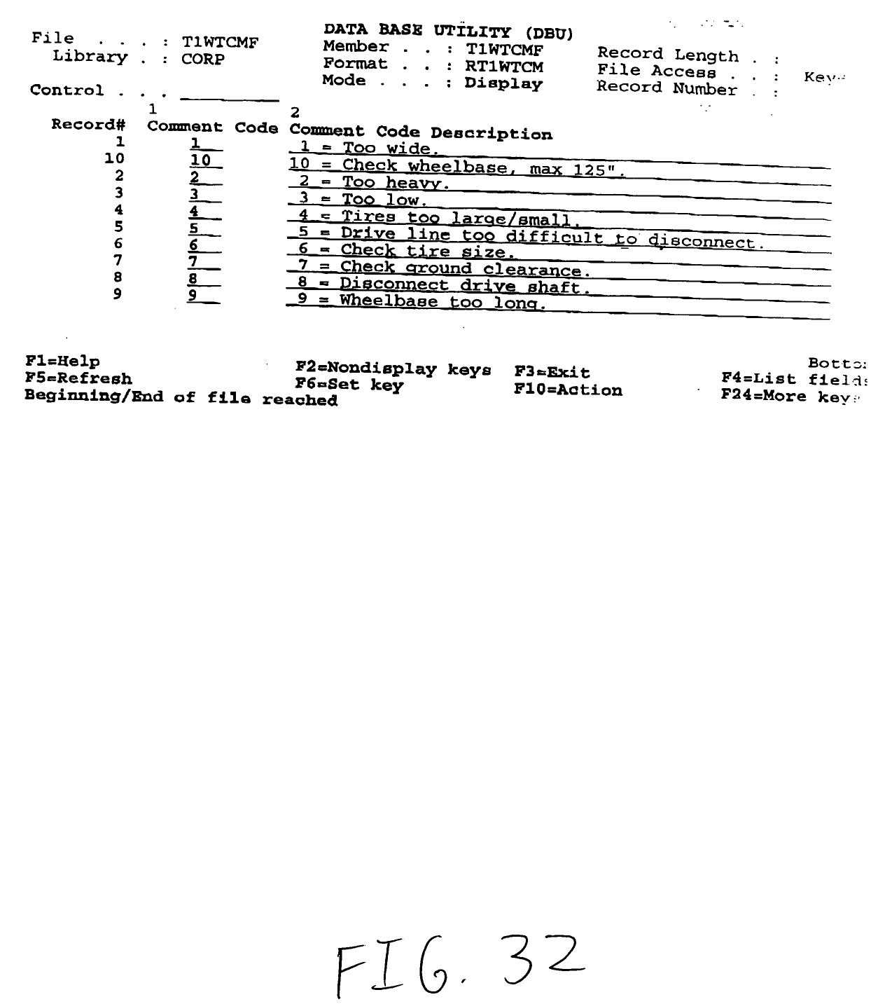

The towing table 34 may store data structures shown, for example, in FIG. 30 for retaining vehicle information, such as the sample towability records for specific vehicles shown in FIGS. 31A-31C which use data codes and comments shown in FIG. 32 for providing towability advice.

The user-accessible data sets may include data corresponding to web pages stored in memory in the backend 14 for display on the browsers of users 24-26 to provide, for example, input forms. The memory also stores predetermined truck rental data, for example, stored in tables of truck information 28, affiliate locations and directions 30, and discount data 32. The expertise-based data set includes a table 34 of vehicle towing information. Through an Internet browser and respective ISP, a user 24 may select equipment including a selection of a truck for rental and a selection of a vehicle type for towing by the selected truck, and in response the server 12 accesses the towing table 34 to determine if the selected vehicle is capable of being towed by the selected truck, and to generate a towing advice indication to the user as to whether the selected truck is appropriate for towing the selected vehicle, with such towing advice indications being sent to the user's computer through the communications interface, for example, to be displayed through the browser.

The expertise-based data set may also include an affiliate table 30 of truck-rental affiliates including geographic locations and a direction table storing travel directions to the affiliates. The user 24 then inputs selections of a departure location and a destination location through forms displayed on the browser, as describe herein, and the server 12 in response accesses the affiliate table 30 to determine the closest affiliates to the departure and destination locations, and accesses travel directions corresponding to the departure and destination locations, respectively. The server 12 then provides the travel directions to the user's computer through the communications interface via the browser.

The backend 14 may include a payment-processing sub-system 36 for establishing payment arrangements with the customer in response to user inputs corresponding to payment information. In addition, the user may input indications of the user being eligible for discounts, and the server 12 in response generates a quote for rental of a selected truck from the user-accessible data sets, and adjusts the quote using a discount determined from the discount data 32 corresponding to the user inputted discount eligibility.

The user inputs truck selection, departure and destination locations, and a pickup date, and the server 12 generates a service contract data set, including a quote for the truck rental, associated with the user to be provided to the user's computer through the communications interface via the browser of the user. The user inputs may also include a selection of moving accessories, which may be stored in a table in the backend 14, and the server 12 generates the service contract data set associated with the user which includes the costs for the accessories in the quote for the truck rental.

Upon input of a reservation confirmation command from the user, the server 12 generates a confirmation message to be provided to the user's computer through the communications interface, for example, for display and/or print out by the browser.

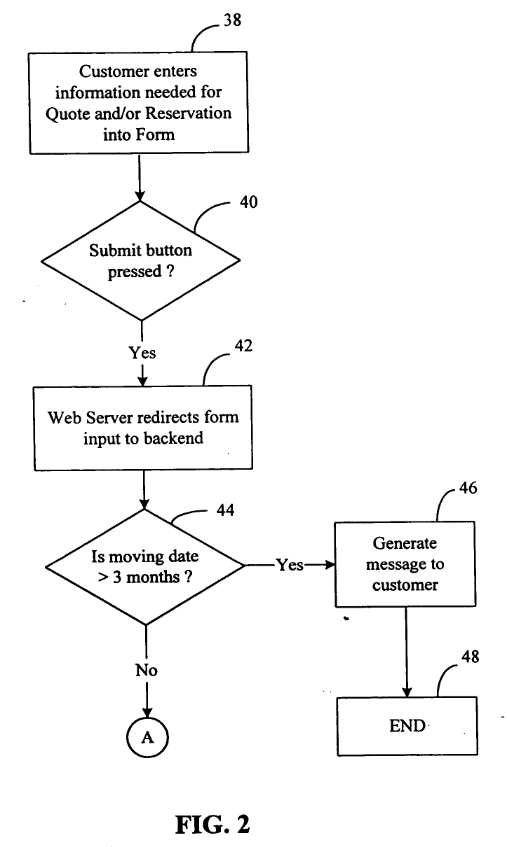

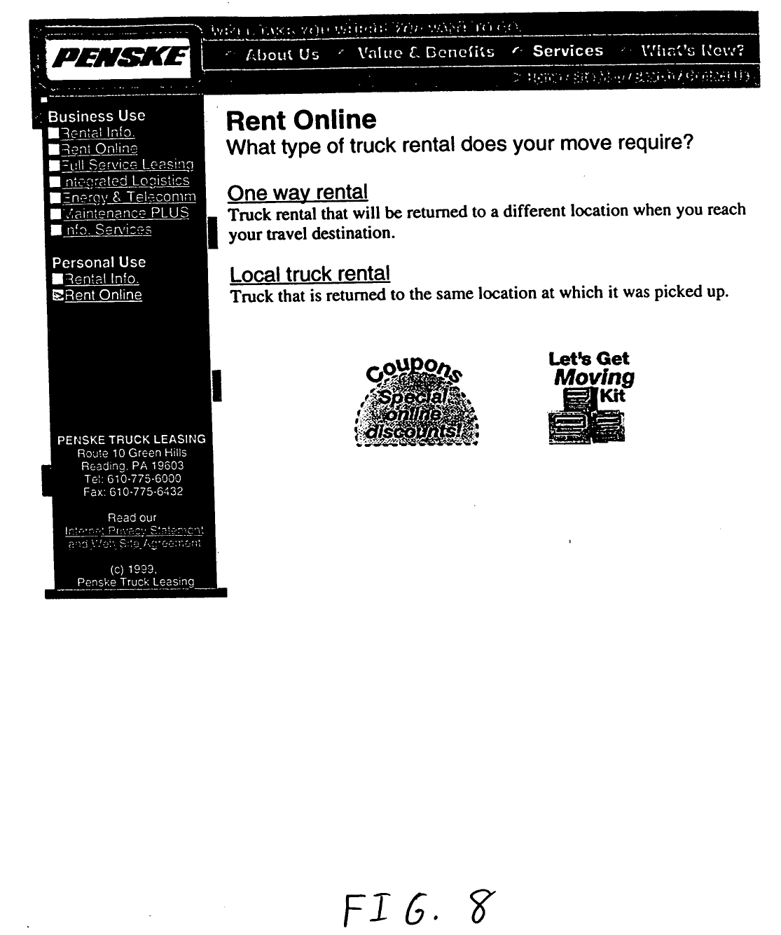

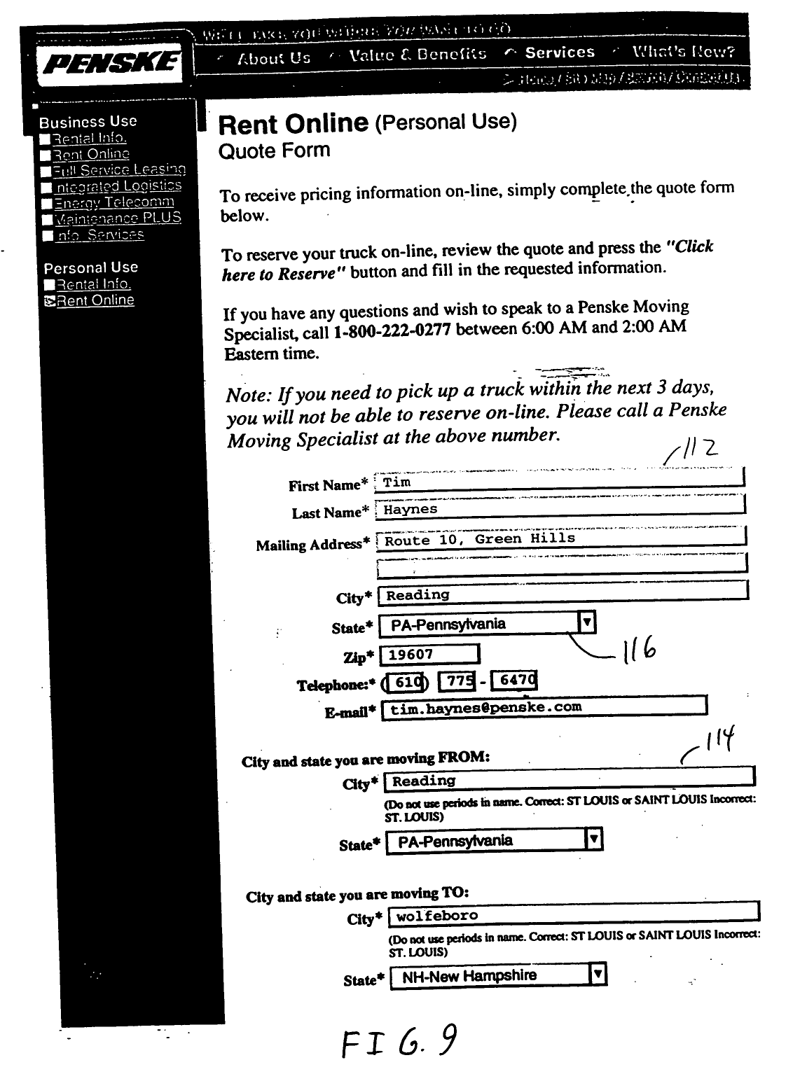

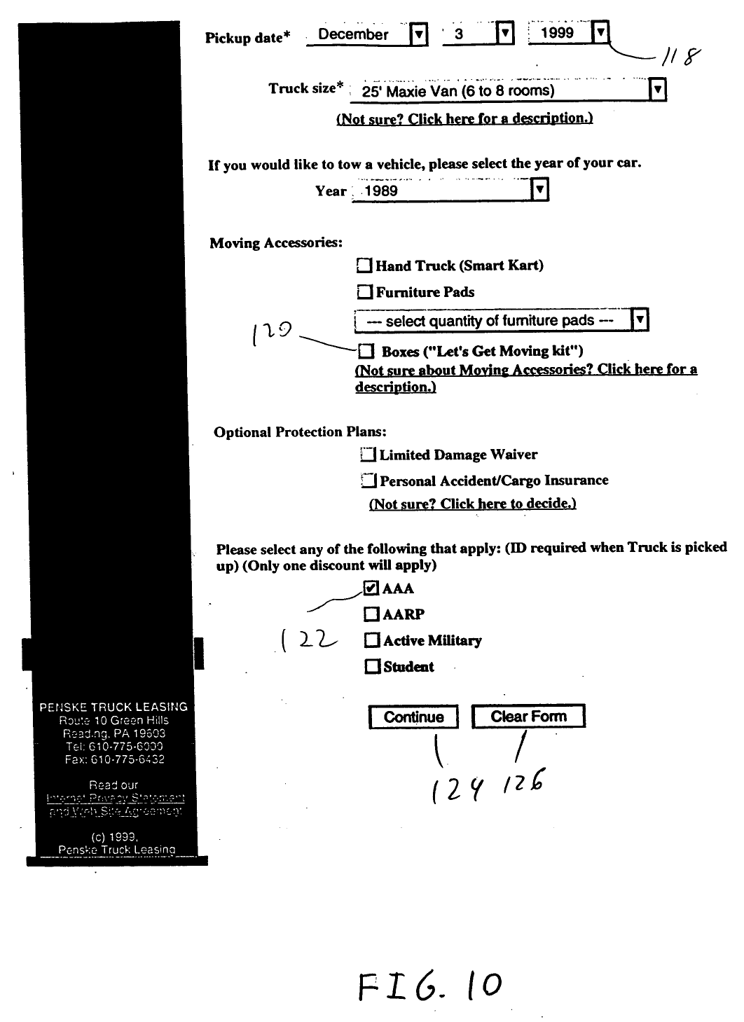

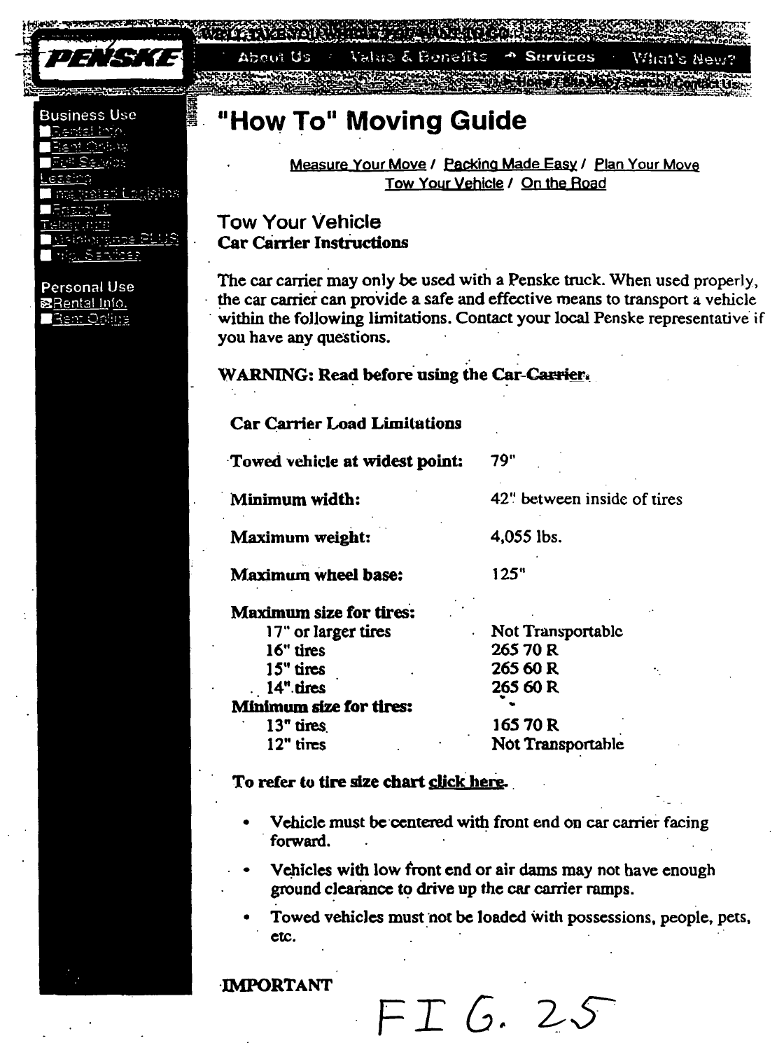

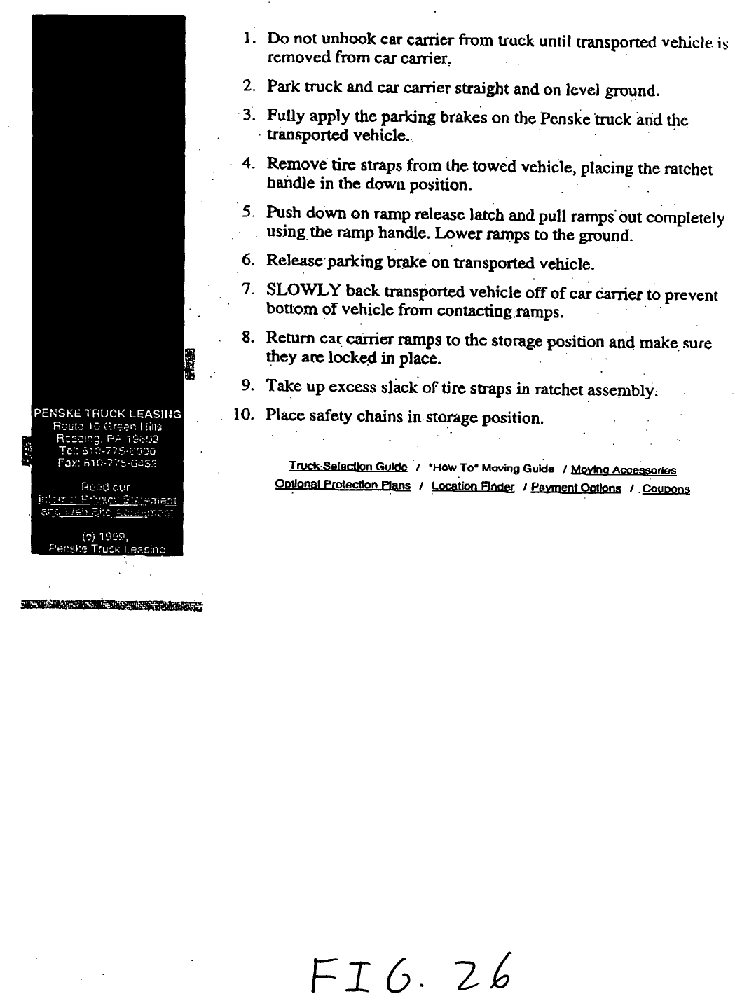

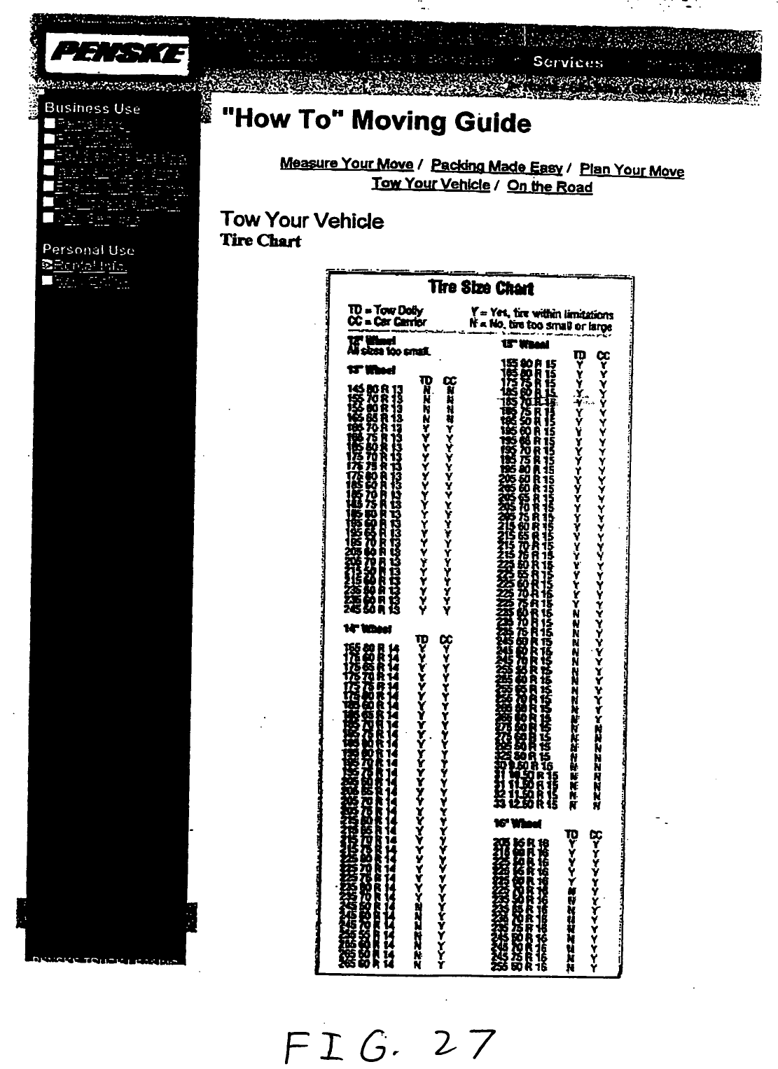

As shown in FIGS. 2-7 with reference to the webpages and forms shown in FIGS. 8-27, the overall operation of the system 10 is illustrated, in which an initial rental webpage is displayed as shown in FIG. 8 with hotlinks to select one-way rental or local truck rental. The forms may be generated as common gateway interface (CGI) scripts using the “PERL” scripting language and stored as a portion of the plurality of user-accessible data sets. For one-way rental, the customer is presented with a quote form as shown in FIGS. 9-10, in which a customer enters in step 38 the information needed for a quote and/or a reservation. The user is provided with input lines or fields such as the fields 112-114, as well as pull-down menus and windows 116, 118 for selecting an input value from a range of predetermined values, such as states in window 116, and years in window 118. Checkboxes 120, 122 and/or radio buttons are also provided for specifying choices of moving accessories, optional protection plans, and discount eligibility. Other actuatable icons include a CONTINUE icon 124, which may also be labeled SUBMIT, as well as CLEAR FORM icon 126 to clear the form.

If the CONTINUE/SUBMIT button is pressed in step 40, the web server 12 redirects the form inputs to the backend 14 in step 42, which processes the form inputs. For example, the moving date entered in the pickup date windows, including window 118, is checked in step 44, and if the moving date is greater than, for example, three months, the backend 14 causes the web server 12 to generate and send a message to the customer in step 46 to indicate that moving dates beyond three months are not supported by the system 10. The operation ends in step 48, and may return to the input forms of FIGS. 9-10 to permit the user to change the dates and resubmit the form inputs.

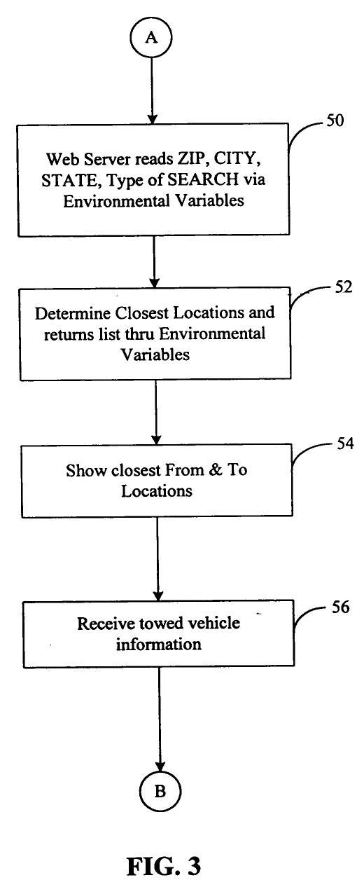

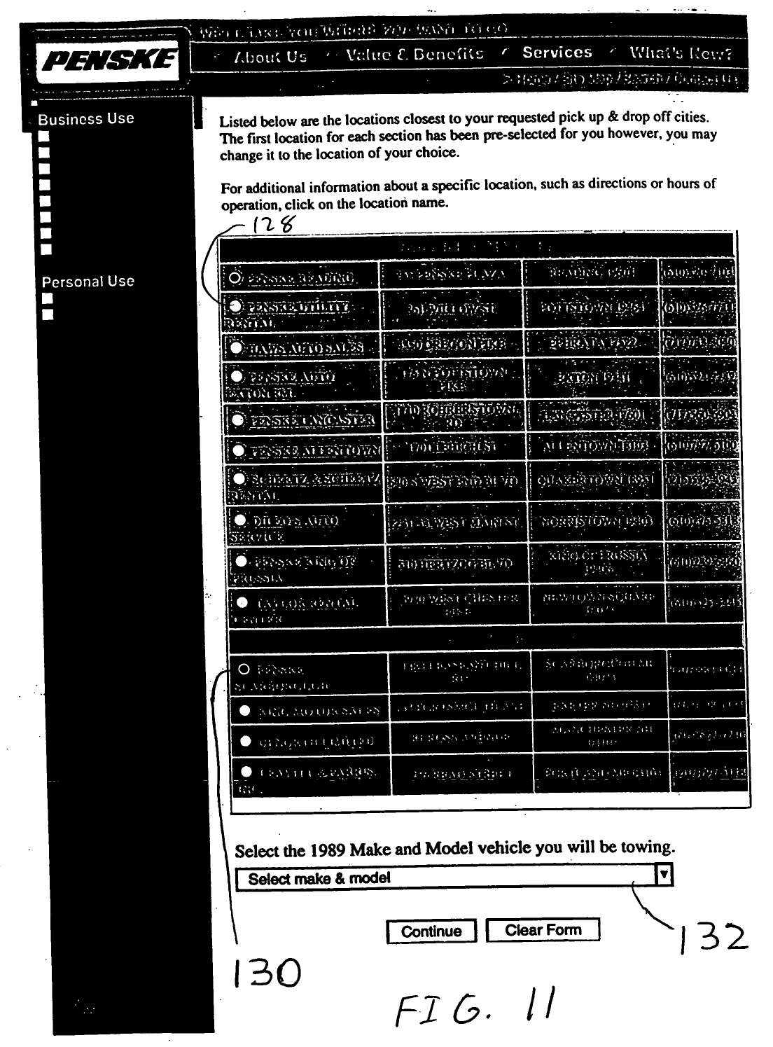

Referring to FIG. 3, the web server 12 and/or the backend 14 then read the address information in step 50, and determine the type of search or information requested according to environmental variables; that is, the geographic locations and proximity of affiliate locations to the address inputted by the user, including the information in fields 112-116. The determination by environmental variables may be performed using mapping and travel software known in the art. The affiliate table 30 is consulted, and the system 10 determines in step 52 of FIG. 3 the closest locations, and the backend 14, through the web server 12, returns a list of closest locations, which are provided and/or displayed to the user in a webpage, for example, as shown in FIG. 11, as determined through the environmental variables. The list shown in FIG. 11 may include radio buttons 128, 130 to allow the user to select a particular affiliate near the departure or FROM location, and the affiliate near the destination or TO location, respectively.

Through the form in FIG. 11, the user also enters vehicle information from a pull-down menu 132, and the backend 14 receives the towed vehicle information in step 56 for later processing.

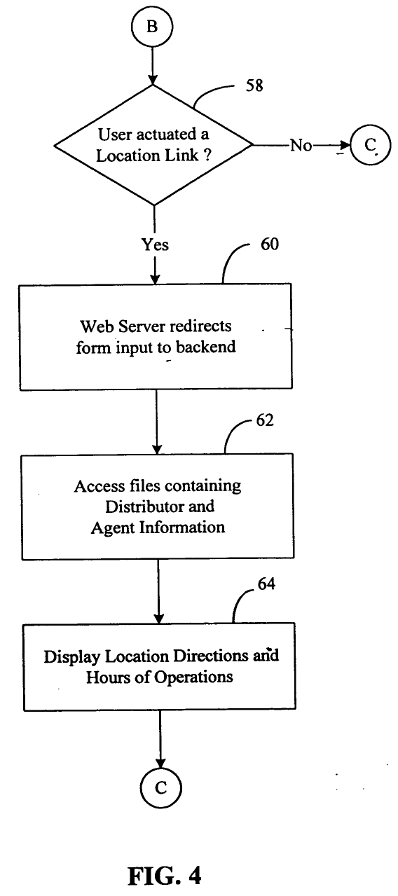

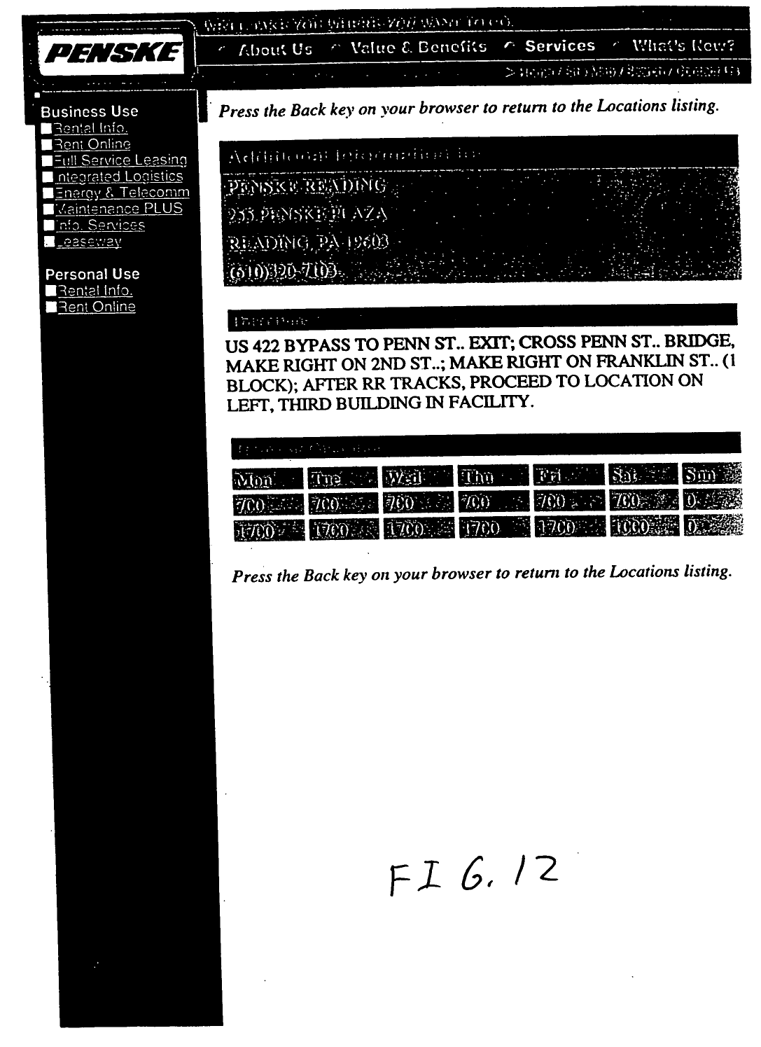

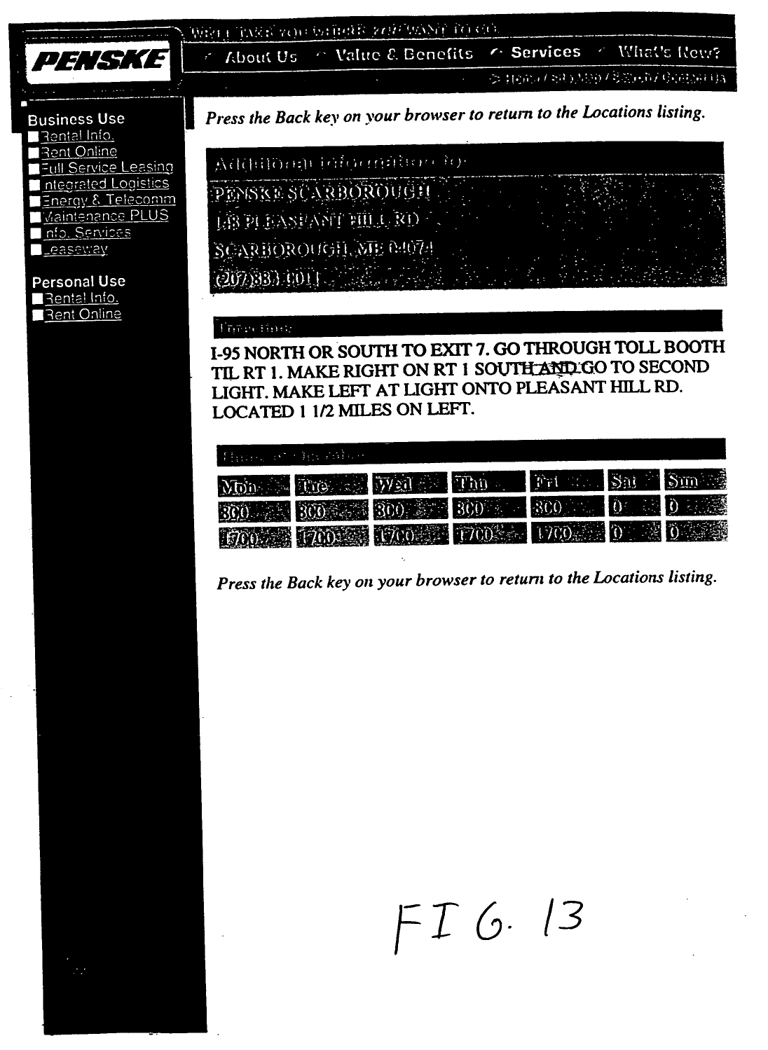

As shown in FIG. 4 with reference to FIG. 11, if the user actuates a location link in step 58, for example, by actuating the radio buttons 128, 130 adjacent to a selected affiliate location, the method proceeds to step 60; otherwise, the method proceeds to step 66. In step 60, the web server 12 passes the form inputs from FIG. 11 to the backend 14, which access the affiliate table 30 to access fields containing distributor and agent/affiliate information in step 62 to find the affiliates selected by the user through FIG. 11. The backend 14 locates the associated directions and hours of operation of the selected affiliates, which are then passed through the web server 12 for display at the browsers of the user in step 64, for example, for the FROM and TO locations in FIGS. 12-13 respectively. The user may return to the Locations listing in FIG. 11 using the BACK key of the browser. The method then proceeds to step 66.

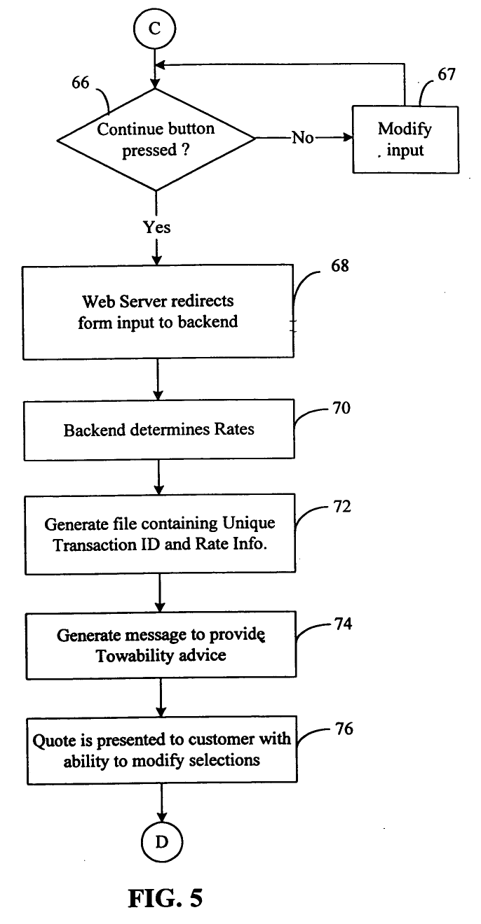

In step 66, the user may then change the inputs in step 67 and/or actuate the CONTINUE icon in FIG. 11 to complete the generation of the quote by steps 68-76 in FIG. 5. In step 68, web server 12 receives the most up-to-date selections of the user, and redirects the form inputs to the backend 14, which determines the rates from all of the users inputs and selections in step 70. The system 10 then generates a file in step 72 which is associated with the user and which contains a unique transaction identification (ID) code and rate information based on the user's inputs. If the user also selected a vehicle to be towed via input window 132 in FIG. 11, the backend 14 also generates a message in step 74 to provide towability advice to the user. The towability advice is generated using the expertise of, for example, automotive manufacturers as to the requirements or limitations of towing a specified vehicle behind a rental truck. The expertise may be stored in records in the table 34, such as the records shown in FIG. 31A-31C using the codes shown in FIG. 32, in which one or more vehicles are listed with a corresponding message regarding advice or limitations to tow the corresponding vehicle.

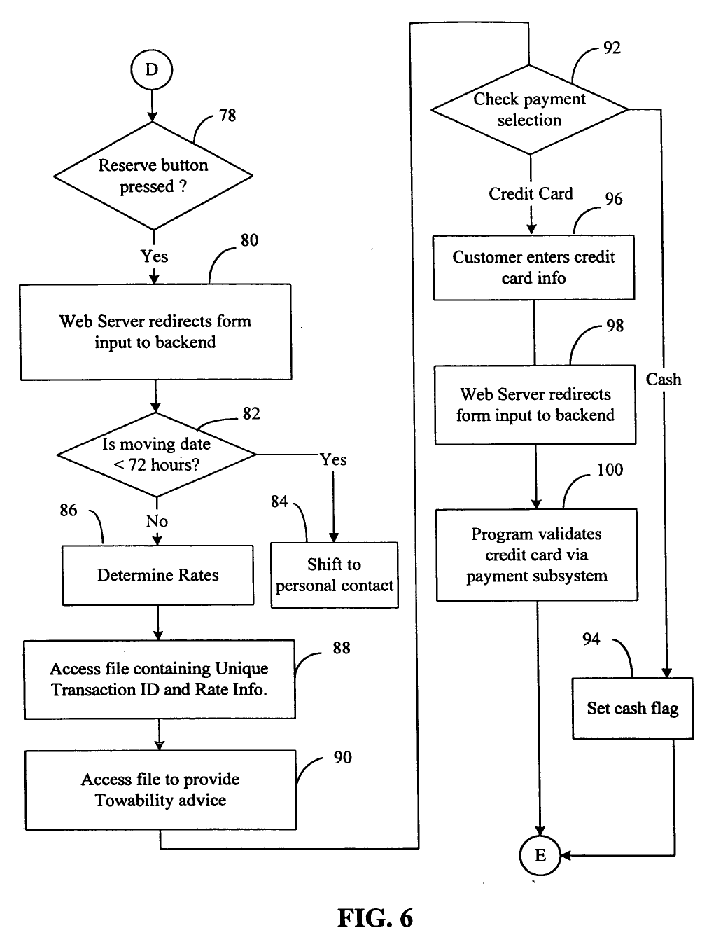

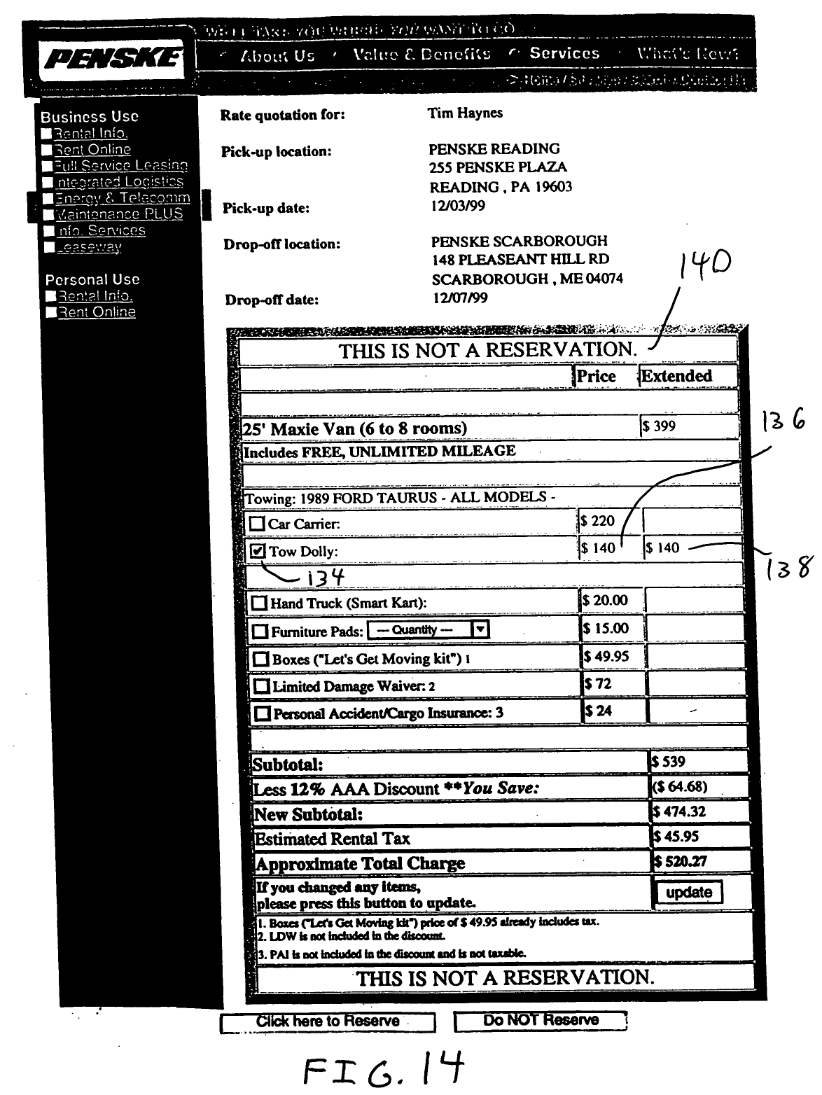

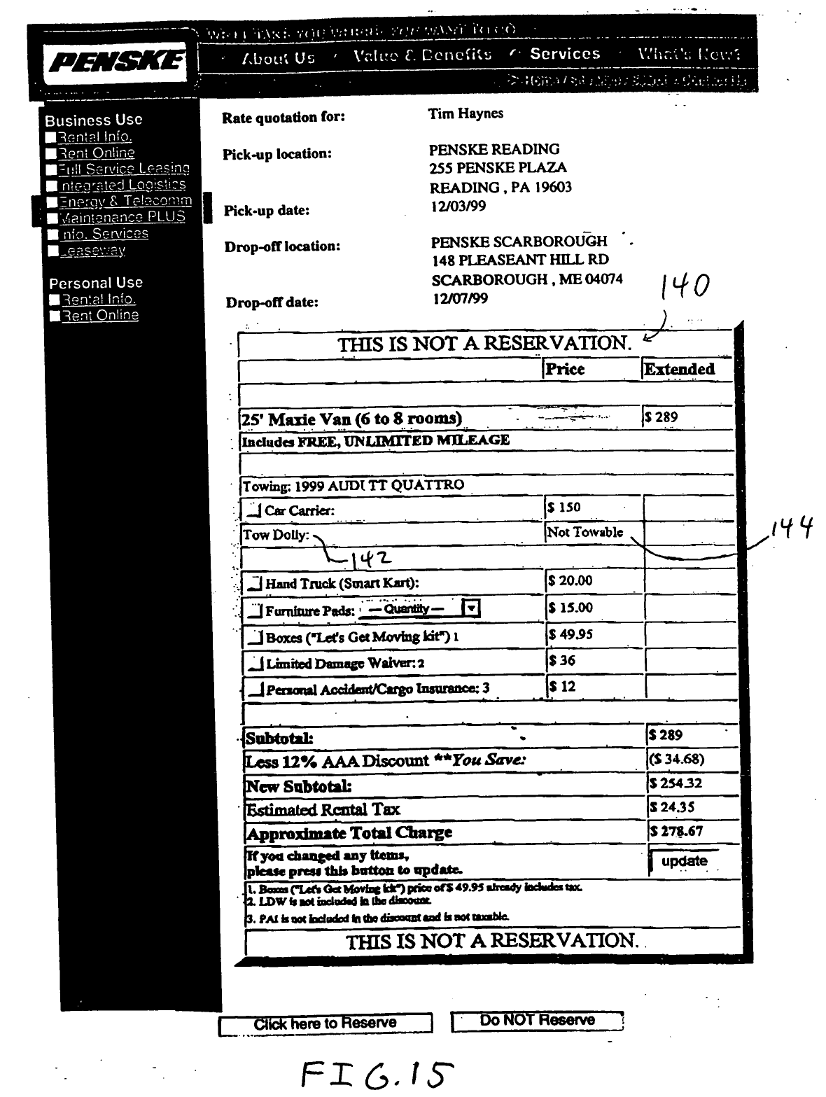

The system 10 then presents the quote as well as the towability advice message, if applicable, to the user in step 76 through the forms shown in FIGS. 14-15. Such forms may be modified as desired by the user before the user completes the reservation. The user is prompted to indicate any change of information by pressing the UPDATE icon, and a reservation is initiated by pressing the RESERVE or CLICK HERE TO RESERVE icon shown in FIGS. 14-15. If the RESERVE button is pressed in step 78 shown in FIG. 6, the web server 12 redirects the form inputs to the backend 14 in step 80 for further processing.

If a vehicle is specified by the user in the input field 132 of FIG. 11, the system 10 determines from the towability table 34 if the vehicle is towable. If towability is allowed, then the user is presented with the form shown in FIG. 14, with a checkbox 134 provided to offer the user the option to include a tow dolly at the specified price shown in field 136. Once the user checks the checkbox 134, the price of the tow dolly is displayed in field 138 and added to the overall cost of the reservation. In addition, the form shown in FIG. 14 provides only a tentative reservation information sheet and does not represent a confirmed reservation. Accordingly, a warning such as THIS IS NOT A RESERVATION is displayed to the user in the field 140 shown in FIG. 14. The field 140 may also be color coded, such as colored in red, to be more readily noticed by the user.

However, if towability of the vehicle specified in field 132 is not allowed, then the user is presented with the form shown in FIG. 15, with no checkbox provided in the tow dolly field 142 comparable to the checkbox 134 in FIG. 14, so the user does not have the option to include a tow dolly in the reservation. In addition, a message may be displayed in field 144 indicating to the user that the specified vehicle is NOT TOWABLE. The field 144 may also be color coded, such as colored in red, to be more readily noticed by the user.

Similar to the form shown in FIG. 14, the form in FIG. 15 provides only a tentative reservation information sheet and does not represent a confirmed reservation. Accordingly, a warning such as THIS IS NOT A RESERVATION is displayed to the user in the field 140 shown in FIG. 15. The field 140 may also be color coded, such as colored in red, to be more readily noticed by the user.

The backend then checks in step 82 if the moving date is less than 72 hours. If so, the system 10 sends the user a message to confirm the moving date and thence to contact a telephone service center in step 84 to provide personal contact to insure and finalize the moving specifics in such a short time period. Otherwise, the system 10 proceeds to step 86 to continue the automated processing of the user's reservation. The user, in response to step 84, may have updated the moving date information, so in steps 86-90, the backend 14 reprocesses the user's information to determine the rates in step 86, to generate and/or update the user's file with the user's unique transaction ID and rate information in step 88, and to provide the user with updated towability advice in step 90.

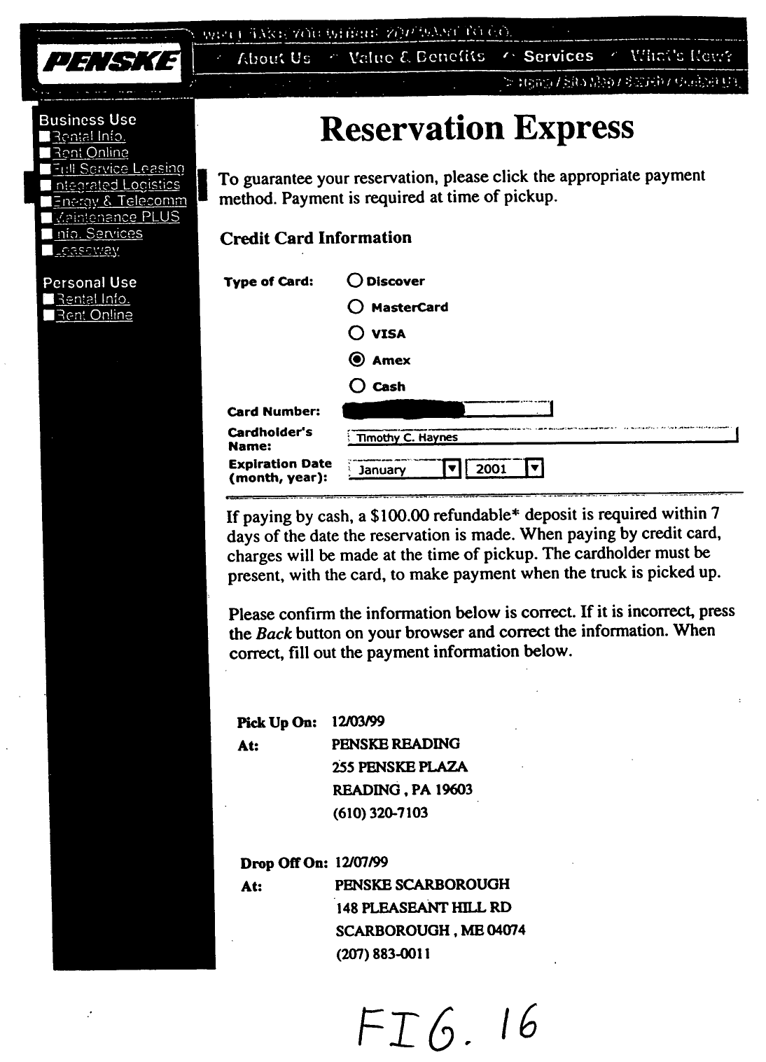

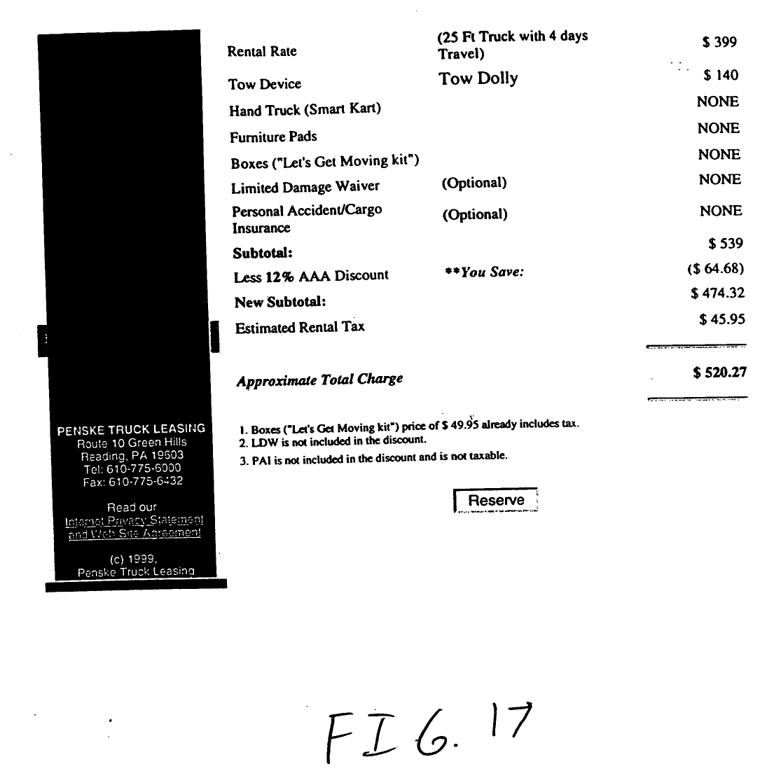

In step 92, the system 10 then displays a payment webpage shown in FIGS. 16-17 listing the finalized reservation and quote information. The backend 14 checks the payment selection to be either cash or credit card. If cash payment is selected, the system 10 sets a cash flag 94 and proceeds to step 102. Otherwise, in step 92, if a credit card is selected for payment, the user enters in step 96 the credit card information in the available fields in FIG. 16.

The web server 12 then redirects the form inputs in step 98 to the backend 14, and a payment sub-system 36 is accessed in step 100 to validate the credit card information. Upon validation, the system 10 proceeds to step 102 to determine if the user chooses to complete the reservation. If the user has pressed the RESERVE button shown in the form in FIG. 17, the web server 12 redirects the form inputs to the backend 14 in step 104, and the backend 14 accesses the file associated with the user and the reservation in step 106 to complete the reservation and to forward such information to the appropriate affiliate to prepare the specified rental truck and accessories by the pick-up date.

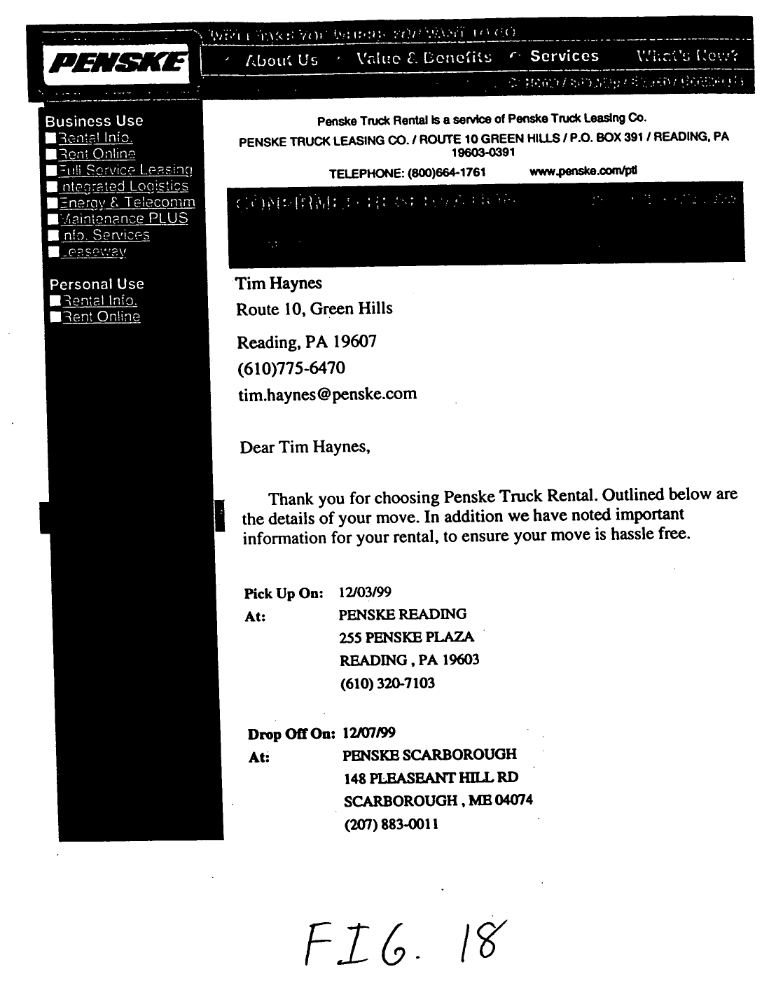

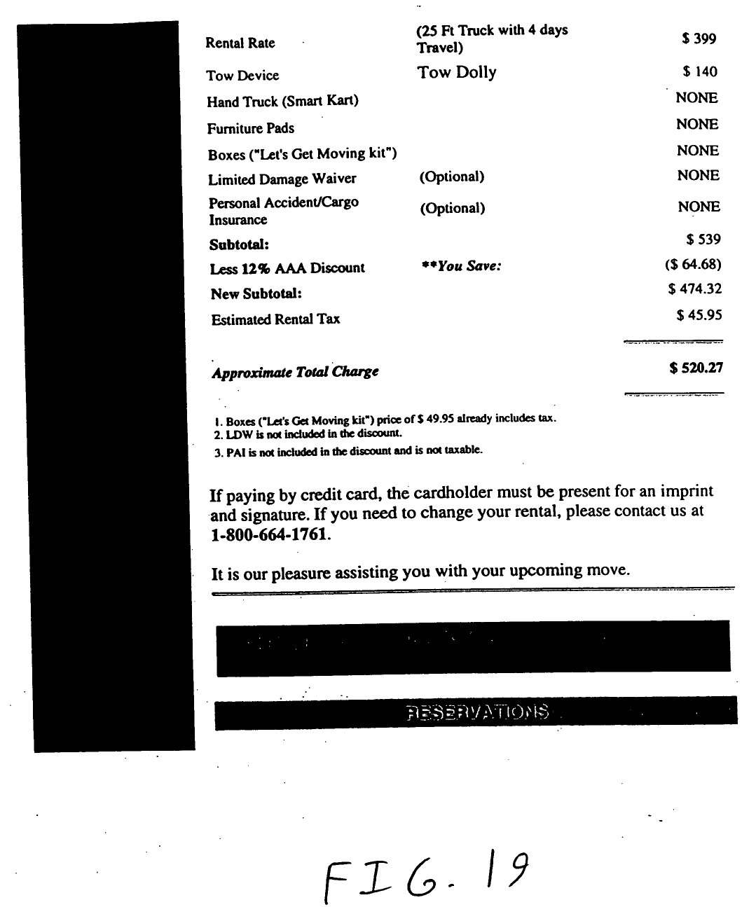

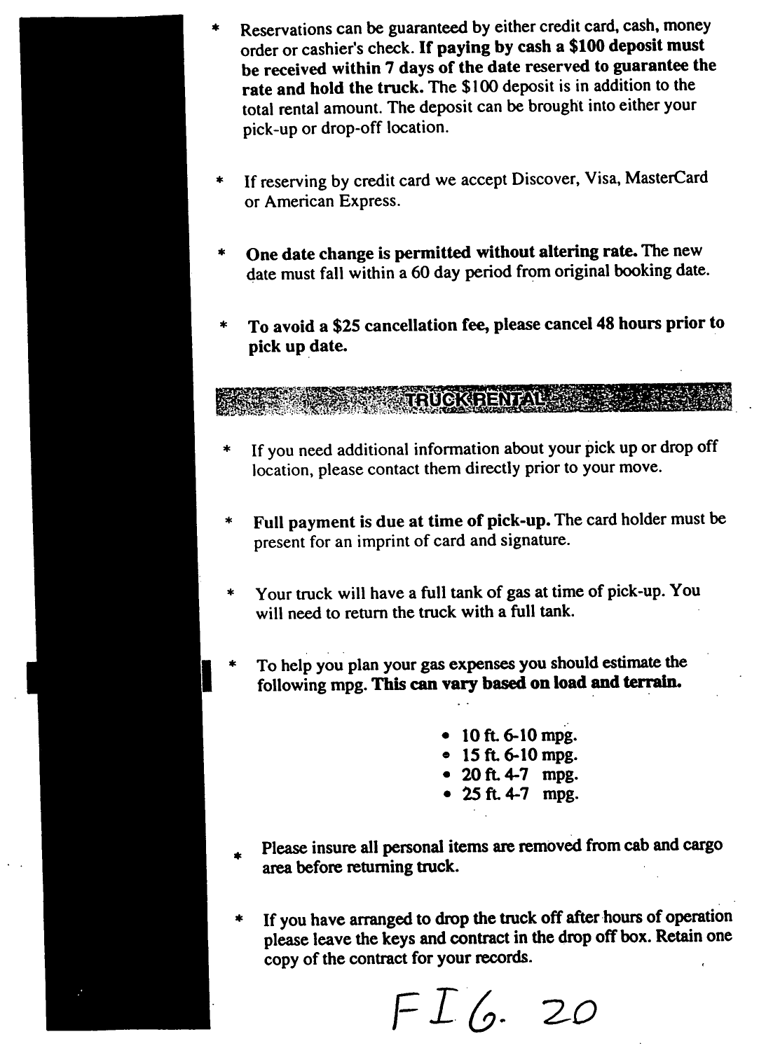

The backend 14 then generates display information to be passed through the web server 12 to the user/customer in step 108 which provides a confirmation page, as shown in FIGS. 18-19, which the user may keep for his/her records and which may be printed out. The web server 12 may also send a supplemental information web page, which may be a standard information sheet and/or disclaimers, as shown in FIG. 20, for viewing and printing by the user.

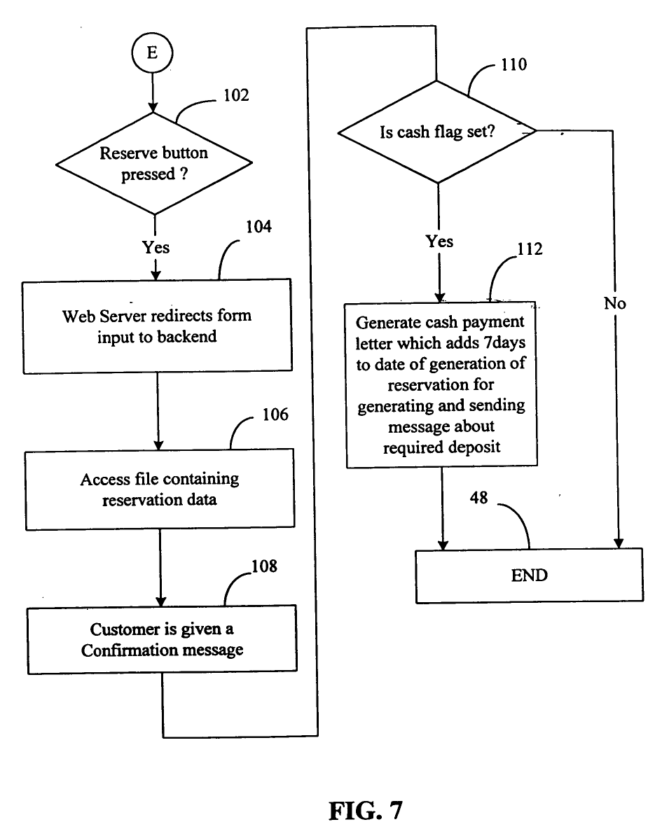

Referring to FIG. 7, the system 10 proceeds to step 110 to check if the cash flag had been set for the user's reservation. If not, the reservation process ends in step 48. Otherwise, if cash payment is selected, the backend 14 generates in step 112 a cash payment letter to be sent to the user/customer via mail, E-mail, or other transmission methods. The cash payment letter is generated to add seven days to the date of the reservation in which time the user is to provide a required cash deposit for the cash transaction. The reservation process then ends in step 48.

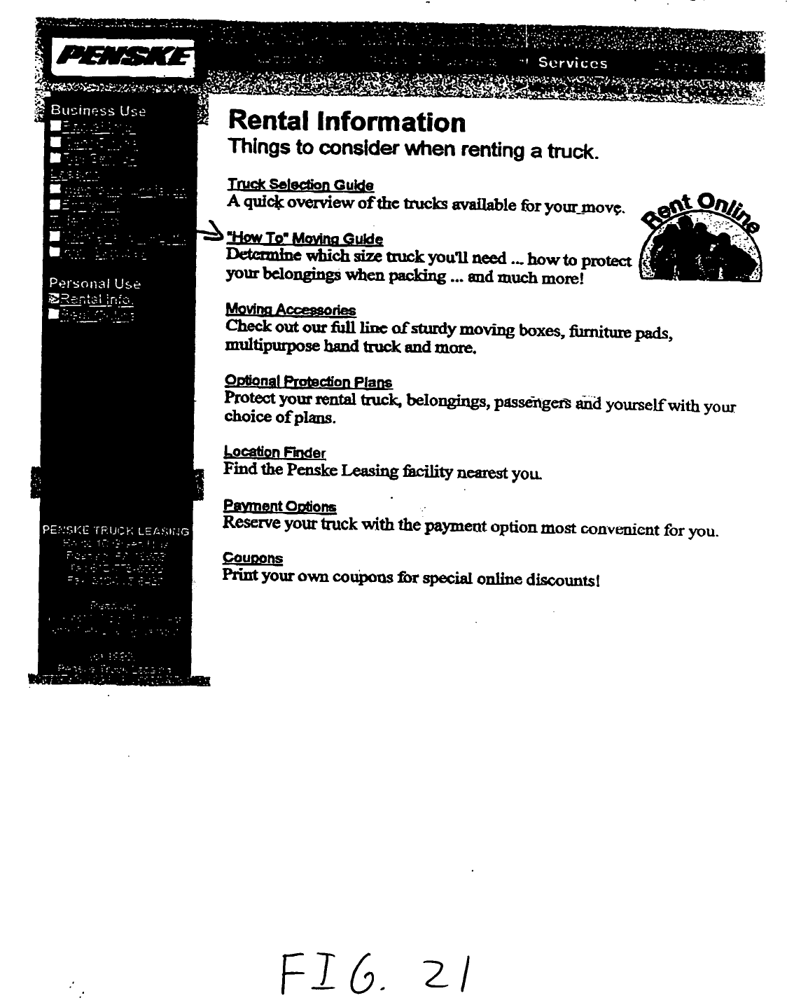

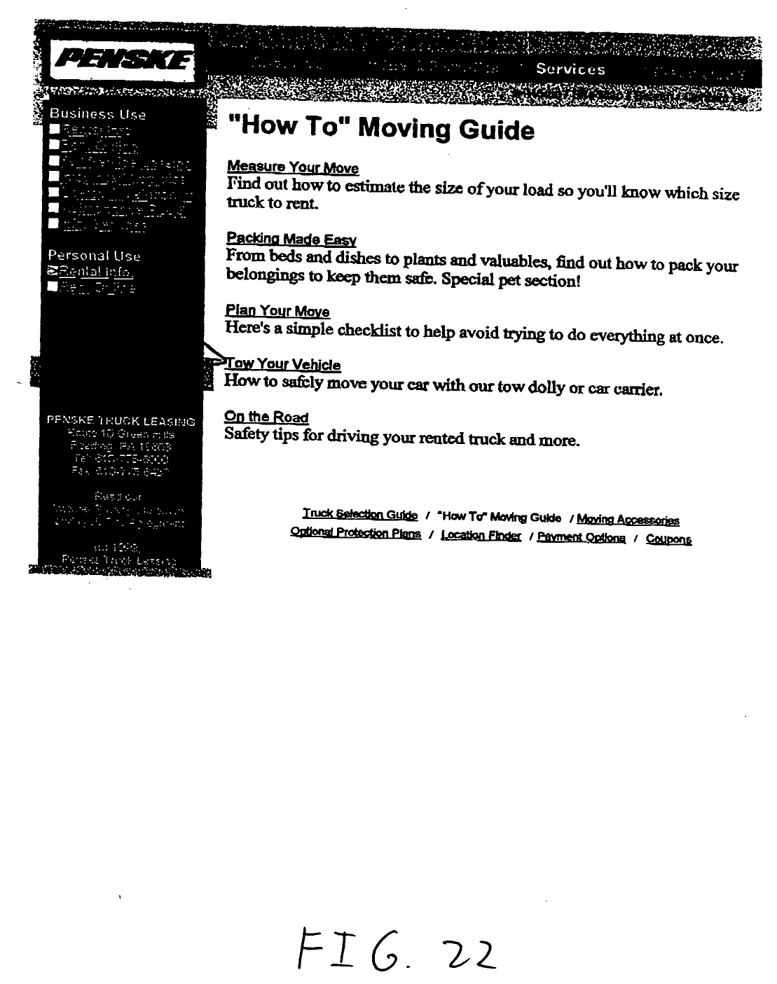

By implementing the disclosed system 10 in an Internet-accessible environment, customers may receive invaluable supplementary information to facilitate both their rental and the use of an appropriate truck and towing equipment. For example, the web server 12 may access, upon user input, web pages shown in FIGS. 21-27 to provide information screens for towing a car with a car carrier or with a tow dolly. From FIG. 21, hotlinks are provided to access multiple information screens, such as truck selection guides, how-to moving guides, moving accessories, optional protection plans, location finder information, payment options, and coupons or other promotions. For example, using the how-to moving guide selection in FIG. 21, the user is presented with additional options shown in the web page of FIG. 22 which are specific to the move, with access provided by hotlinks to information for properly towing a vehicle behind the rental truck.

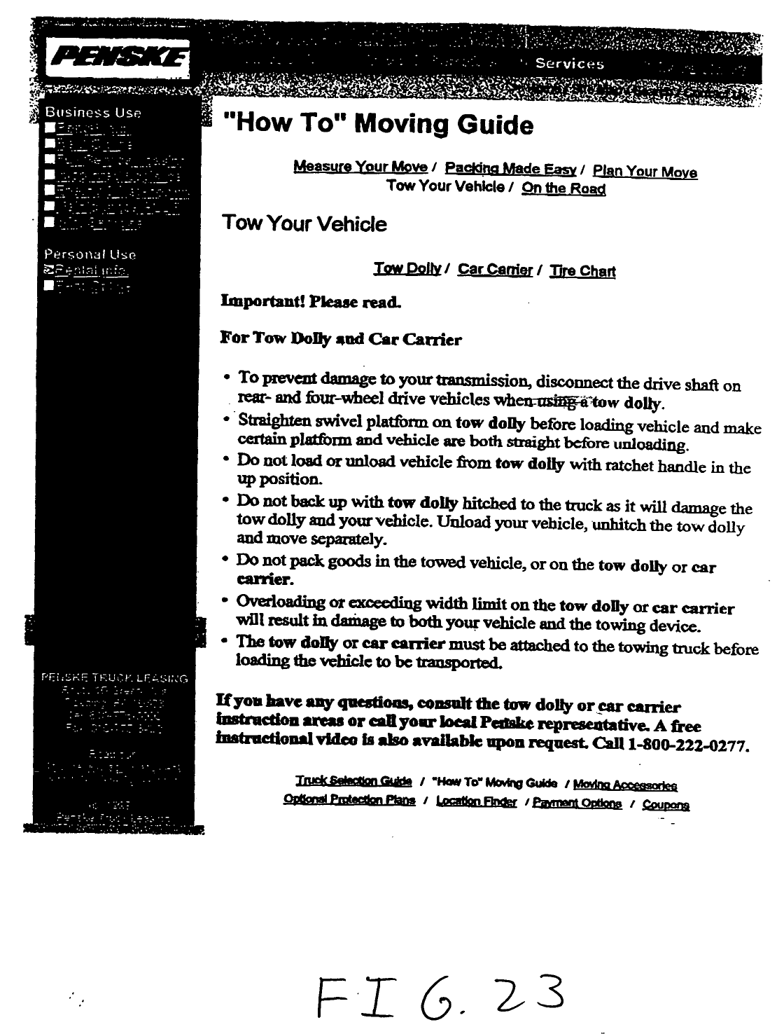

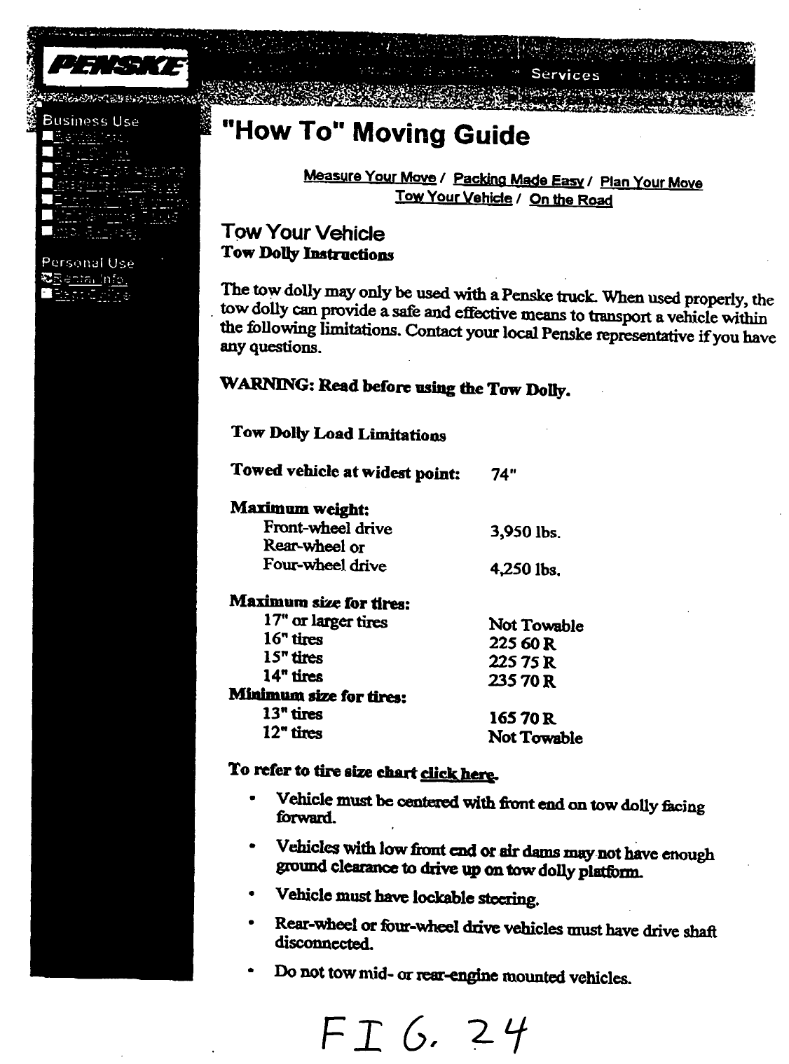

By actuating the TOW YOUR VEHICLE hotlink, the web page shown in FIG. 23 provides additional information and options, such as hotlines for information about tow dollies, car carriers, and a tire chart, portions of which are shown in FIGS. 24-27. Additional information web pages and/or hotlinks may be provided to permit the user to selectively access additional information.

The disclosed computerized truck rental system 10 and method have been described by way of the preferred embodiment. However, numerous modifications and substitutions may be made without departing from the spirit of the invention. For example, while the preferred embodiment discusses using the Internet, it is wholly within the purview of the invention to contemplate a non-Internet-based on-line and/or proprietary communications system for supporting the disclosed truck-rental and reservation system and method providing both information and expertise in the manner as set forth above. Accordingly, the invention has been described by way of illustration rather than limitation.

1 to 25. (canceled)

26. A method for facilitating truck rental via a computer system, comprising:
displaying a web page to a user, the web page including a form;
storing truck information;
storing vehicle towing information;
receiving user input via the form, the user input including a selected truck for rental and a selected vehicle for towing by the selected truck; and
determining if the selected vehicle is capable of being towed by the selected truck on the basis of the truck information and the vehicle towing information.

27. The method of claim 26, wherein the selected vehicle includes year, make and model information.

28. The method of claim 26, further comprising:
providing towing advice information indicating desired towing accessories, the towing advice information provided on the basis of the vehicle towing information and the selected vehicle.

29. The method of claim 28, wherein the towing accessories include a towing dolly and a car carrier.

30. The method of claim 26, wherein the truck information includes types of trucks and truck rental prices.

31. The method of claim 26, wherein the vehicle towing information includes manufacturer information for at least one of width, length and height information for towing vehicles.

32. The method of claim 26, wherein the vehicle towing information includes towing accessory information and towing accessory rental prices.

33. The method of claim 26, wherein the computer system includes a payment-processing sub-system; and
wherein the method further comprises the steps of:
receiving user payment input; and
establishing payment arrangements on the basis of the user payment input.

34. The method of claim 33, wherein the payment-processing sub-system includes credit-card processors; and
wherein the user payment input includes credit card information.

35. A system, comprising:
a processor;
at least one arrangement configured to communicate with the processor via a communications network;
a computer-readable storing medium storing a set of instructions, the set of instructions capable of being executed by the processor to implement a method for facilitating truck rental, the set of instructions effective to perform the steps of:
displaying a web page to a user, the web page including a form;
storing truck information;
storing vehicle towing information;
receiving user input via the form, the user input including a selected truck for rental and a selected vehicle for towing by the selected truck; and
determining if the selected vehicle is capable of being towed by the selected truck on the basis of the truck information and the vehicle towing information.

36. The system of claim 35, wherein the selected vehicle includes year, make and model information.

37. The system of claim 35, wherein the method further comprises the step of:
providing towing advice information indicating desired towing accessories, the towing advice information provided on the basis of the vehicle towing information and the selected vehicle.

38. The system of claim 37, wherein the towing accessories include a towing dolly and a car carrier.

39. The system of claim 35, wherein the truck information includes types of trucks and truck rental prices.

40. The system of claim 35, wherein the vehicle towing information includes manufacturer information for at least one of width, length and height information for towing vehicles.

41. The system of claim 35, wherein the vehicle towing information includes towing accessory information and towing accessory rental prices.

42. The system of claim 35, wherein the at least one arrangement includes a payment-processing sub-system; and
wherein the method further comprises the steps of:
receiving user payment input; and
establishing payment arrangements on the basis of the user payment input.

43. The system of claim 42, wherein the payment-processing sub-system includes credit-card processors; and
wherein the user payment input includes credit card information.
